(19) United States
(12) Patent Application Publication
(10) Pub. No.: US 2019/0034421 A1
(43) Pub. Date: Jan. 31, 2019

(54) TERMINAL DEVICE AND DISPLAY METHOD

(71) Applicant: Bank Invoice Corporation, Tokyo (JP)

(72) Inventor: Taro TESHIMA, Tokyo (JP)

(73) Assignee: Bank Invoice Corporation

(21) Appl. No.: 16/138,221

(22) Filed: Sep. 21, 2018

Related U.S. Application Data
(63) Continuation of application No. PCT/JP2017/011470, filed on Mar. 22, 2017.

(30) Foreign Application Priority Data
Mar. 25, 2016 (JP) 2016-061817

(51) Int. Cl. G06F 17/30; G06F 3/0482

(52) U.S. Cl. CPC G06F 17/30002; G06F 17/30286; G06F 3/0482

(57) ABSTRACT

A portable terminal device includes a storage unit, a detection unit that detects a screen switching operation performed by a user, and a control unit that displays, with reference to the storage unit, a first screen for displaying a plurality of category names of categories into which the content of invoice data is classified, in a row, and a second screen for displaying data corresponding to each category among data related to the invoice data and that displays data corresponding to an adjacent category name on the second screen according to the screen switching operation detected by the detection unit.

### CROSS-REFERENCE TO RELATED APPLICATION

This application is a continuation application of International Application PCT/JP2017/011470 filed on Mar. 22, 2018, designating the U.S. and claiming priority from Japanese Patent Application No. 2016-061817 filed on Mar. 25, 2016. The entire contents of both foregoing applications are incorporated herein by reference.

### FIELD

The embodiments discussed herein relate to a terminal device and a display method.

### BACKGROUND

There is known a technique for achieving unified management for viewing of business documents (for example, invoices and others) of an entire company or an entire corporate group and information thereof.

For example, there is known an information processing apparatus that has a first storage unit that stores therein user information associating user identification information identifying a user and at least one piece of unique information with each user, a generation unit that generates a code for each user from the unique information and user identification information stored in the first storage unit, under prescribed rules, a second storage unit that stores therein business document information including the user identification information of a first user that is included in the user information stored in the first storage unit, and a processing unit that determines, when receiving a request for access to business document information from a second user whose user information is stored in the first storage unit, whether the first code of the first user matches the second code of the second user, and when the first code matches the second code, gives the second user an access authority to access the business document information created by the first user and stored in the second storage unit.

Please see, for example, International Publication Pamphlet No. WO 2015/049948.

Consider, for example, the case of viewing information about one invoice using a portable terminal device, such as a tablet or a smartphone.

In a situation where a user opens a plurality of tabs or a plurality of windows to view information in a browser or the like, for example, it would be difficult for the user to confirm what information the user is viewing and to determine which tab to select in order to view previously viewed information. In addition, it would be hard to easily search for information that the user wants to see.

### SUMMARY

According to one aspect, there is provided a terminal device including: a memory; a processor configured to perform a process including: detecting a screen switching operation performed by a user; and displaying, with reference to the memory, a first screen for displaying a plurality of category names of categories into which content of business document data is classified and a second screen for displaying data corresponding to each of the categories among data related to the business document data, and displaying data corresponding to one of the category names on the second screen according to the detected screen switching operation, wherein the process further includes displaying a third screen for displaying identification information unique to the business document data, and wherein the process further includes displaying, upon detecting that the user has performed a selection operation on the second screen, detailed data with respect to data that was displayed on the second screen before the detecting of the selection operation, in an area where the second screen has been displayed, while keeping the third screen displayed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to a first embodiment.

FIG. 2 is a view for explaining an example of a screen that is displayed on a terminal device after a login.

FIG. 3 illustrates a hardware configuration of an invoice management apparatus according to the embodiment.

FIG. 4 is a block diagram illustrating functions of the invoice management apparatus according to the embodiment.

FIG. 5 is a view for explaining an example of invoice data.

FIG. 6 is a view for explaining information to be displayed in a summary display area.

FIGS. 7A and 7B are views for explaining information to be displayed in the summary display area.

FIG. 8 is a view for explaining how to process returned invoice data.

FIG. 9 is a view for explaining an example of external communication data.

FIG. 10 is a view for explaining an example of attached file data.

FIG. 11 is a view for explaining an example of data stored in a history data storage unit.

FIG. 12 is a view for explaining an example of data stored in the history data storage unit.

FIGS. 13A and 13B are views for explaining examples of data to be displayed in an information display area in a history display mode.

FIG. 14 is a view for explaining an example of memo data.

FIG. 15 is a view for explaining an example of an external communication list.

FIG. 16 is a view for explaining an example of the external communication list.

FIG. 17 is a flowchart for explaining how a data processing unit operates to find invoice data.

FIG. 18 illustrates a hardware configuration of a portable terminal device according to a second embodiment.

FIG. 19 is a block diagram illustrating functions of the portable terminal device according to the second embodiment.

FIG. 20 is a block diagram illustrating functions of an invoice management apparatus according to the second embodiment.

FIG. 21 is a view for explaining an invoice list screen that is displayed on the portable terminal device after a login.

FIG. 22 illustrates an example of a screen that is displayed on the portable terminal device when an External Communication List display button is tapped, according to the second embodiment.

FIG. 23 illustrates an example of a screen that is displayed on the portable terminal device when a Memo List display button is tapped, according to the second embodiment.

FIG. 24 is a view for explaining a summary of invoice data to be displayed on the display of the portable terminal device.

FIG. 25 is a view for explaining detailed data to be displayed on the display of the portable terminal device.

FIG. 26 is a view for explaining a screen for giving a status.

FIG. 27 is a view for explaining a header detailed data display screen that is displayed on the display of the portable terminal device.

FIG. 28 is a view for explaining a description detailed data display screen that is displayed on the display of the portable terminal device.

FIG. 29 is a view for explaining a total detailed data display screen that is displayed on the display of the portable terminal device.

FIG. 30 is a view for explaining a payee detailed data display screen that is displayed on the display of the portable terminal device.

FIG. 31 is a view for explaining message data to be displayed on a second screen.

FIG. 32 is a view for explaining link information of attached data to be displayed on the second screen.

FIG. 33 is a view for explaining history data to be displayed on the second screen.

FIG. 34 is a view for explaining memo data to be displayed on the second screen.

### DESCRIPTION OF EMBODIMENTS

Hereinafter, an invoice management system according to embodiments will be described in detail with reference to the accompanying drawings.

### First Embodiment

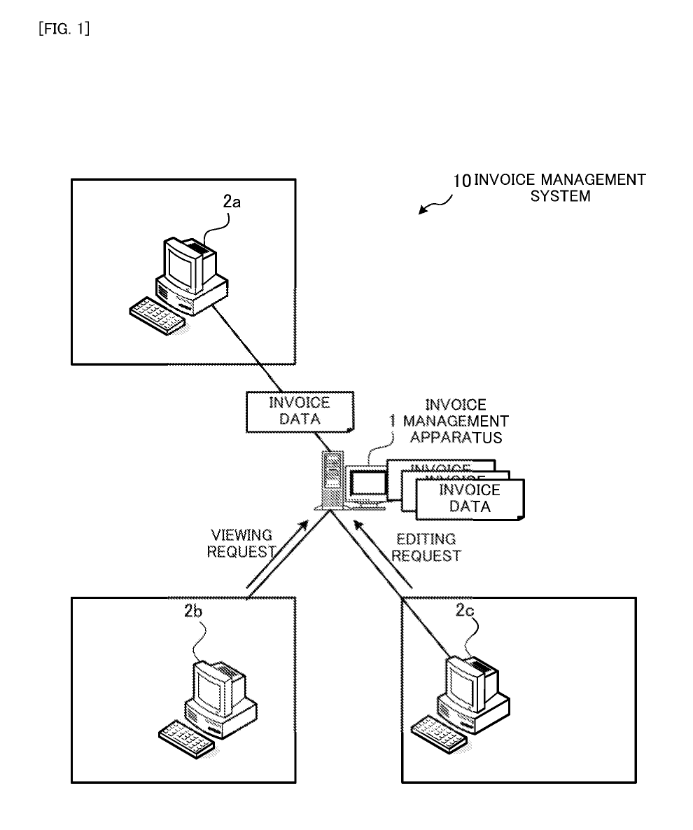

FIG. 1 illustrates an invoice management system according to a first embodiment.

In the invoice management system 10 of the first embodiment, an invoice management apparatus 1 is connected to terminal devices 2a, 2b, and 2c over the Internet or a dedicated network.

The terminal devices 2a, 2b, and 2c are placed at accounting departments of different companies. For example, the terminal device 2a is placed at a company A, the terminal device 2b is placed at a company B, and the terminal device 2c is placed at a company C. Examples of the terminal devices 2a, 2b, and 2c include desktop personnel computers, laptop personnel computers, tablet terminals, and smartphones.

A web program is installed in the invoice management apparatus 1 and the terminal devices 2a, 2b, and 2c. The terminal devices 2a, 2b, and 2c communicate invoice data on invoices with the invoice management apparatus 1 through Web browsers. In this connection, the embodiments explain communication of invoice data, but invoices are an example of business documents and the present invention is not limited thereto. Other examples of business documents include estimate forms, order forms, and prescriptions.

Hereinafter, it is assumed that the invoice management system 10 is used by the individual accounting persons of the companies A, B, and C.

Each accounting personnel of the companies A, B, and C performs user registration to the invoice management apparatus 1 using an assigned Email address or the like, in order to set up a connection to an invoice processing system provided by the invoice management apparatus 1.

After that, for example, the accounting personnel of the company A operates the terminal device 2a to display a login screen (not illustrated) provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting persons are able to operate their terminal devices 2a, 2b, and 2c to process invoice data, which is a digitized version of original invoices, via the invoice management apparatus 1. The processing of invoice data include creation, sending, receipt, viewing, editing, and others.

For example, when the accounting personnel of the company A issues an invoice to the company B, the accounting personnel of the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a, 2b, and 2c. Rather, all invoice data created by the terminal devices 2a, 2b, and 2c and sent to bill-to parties is held by the invoice management apparatus 1. The invoice data is treated like shared data. The invoice management apparatus 1 gives viewing and editing authorities for the invoice data to the terminal devices 2a, 2b, and 2c according to necessity.

The above approach makes it possible to digitize and process original invoices electronically, which leads to saving labor for management and storage of paper- or PDF-based invoices.

As described earlier, invoice data is not communicated directly between the terminal devices 2a, 2b, and 2c. In the following description, however, in the case where invoice data addressed to the mail address of the accounting personnel of the company B is sent from the accounting personnel of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a, 2b, 2c.

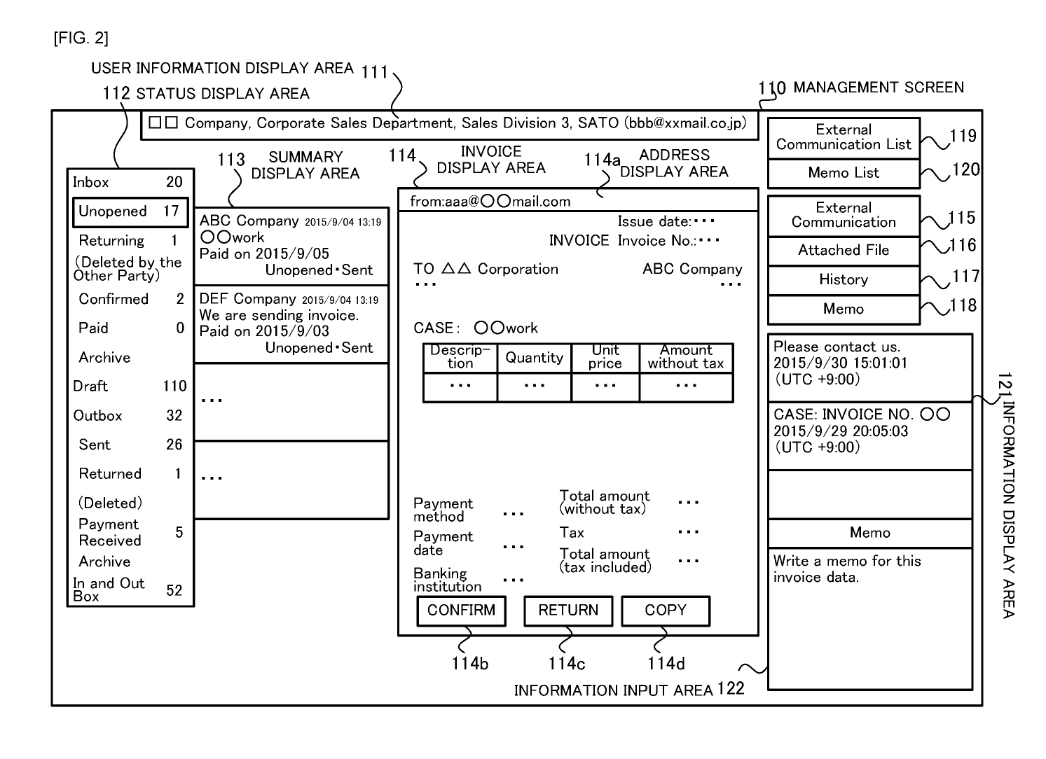

FIG. 2 is a view for explaining an example of a screen that is displayed on a terminal device after a login.

The management screen 110 illustrated in FIG. is an example of a screen to be displayed on the terminal device 2a.

As illustrated in FIG. 2, an accounting personnel is able to create, issue, view, and edit invoice data, like he/she uses mail software.

By the way, in the above-described example, the accounting personnel of the company A is not able to rewrite invoice data once he/she sends it. In addition, the accounting personnel of the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

The management screen 110 will be described in detail later.

Now, the disclosed invoice management system will be described more concretely.

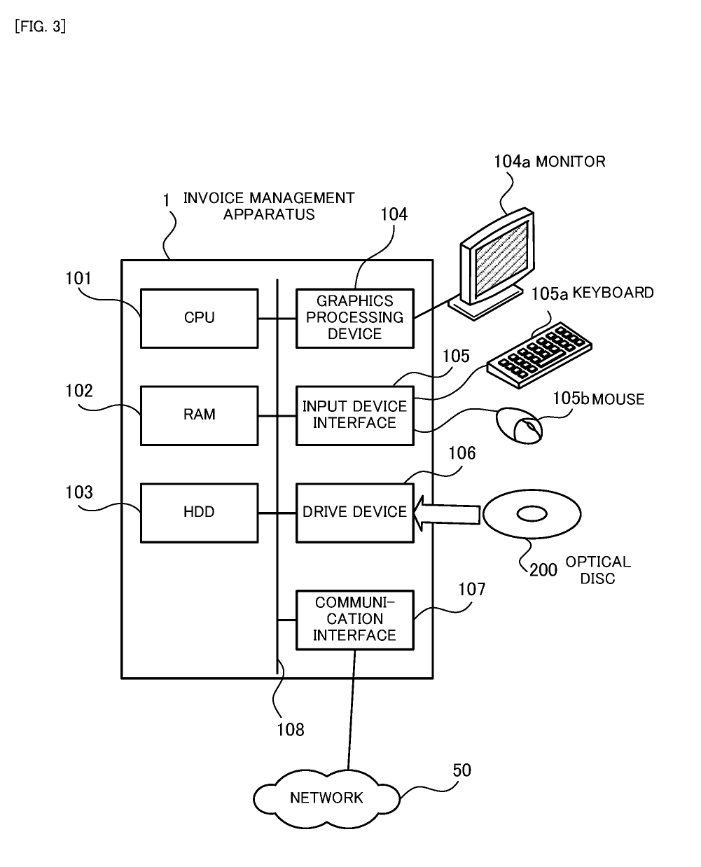

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of OS (operating system) programs and application programs that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. The OS programs, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on the optical disc 200 may be read with laser light or the like. Examples of the optical disc 200 include Blu-ray (registered trademark), DVD (digital versatile disc), DVD-RAM, CD-ROM (compact disc read only memory), CD-R (recordable), and CD-RW (rewritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hard configuration of the invoice management apparatus 1. The other computers including the terminal device 2a may be implemented with the same hardware configuration as the invoice management apparatus 1.

The invoice management apparatus 1 having the hardware configuration illustrated in FIG. 3 has the following functions.

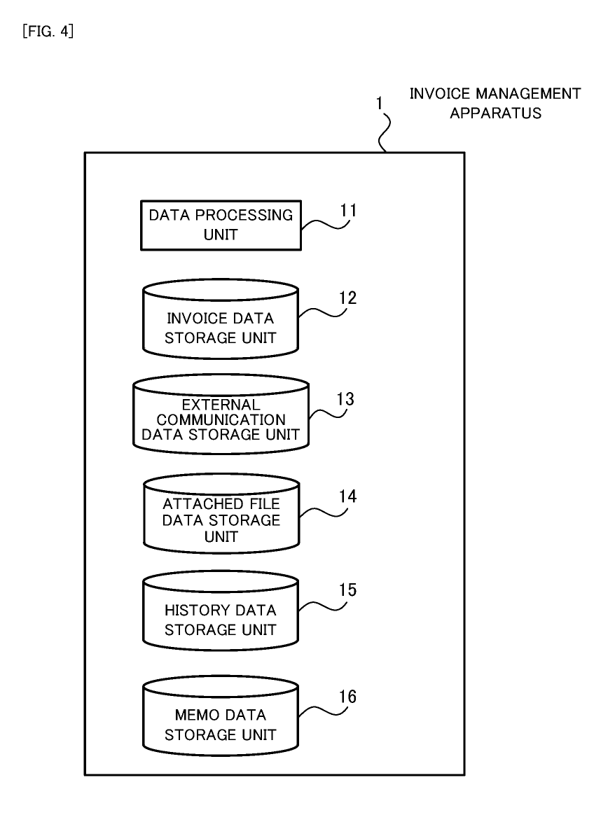

FIG. 4 is a block diagram illustrating functions of the invoice management apparatus according to the present embodiment.

The invoice management apparatus 1 has a data processing unit 11, an invoice data storage unit 12, an external communication data storage unit 13, an attached file data storage unit 14, a history data storage unit 15, and a memo data storage unit 16.

The data processing unit 11 displays the management screen 110 illustrated in FIG. 2 on the terminal device 2a or the like in accordance with accounting personnel's operations. The data processing unit 11 performs appropriate processing according to operations made to invoice data on the management screen 110. For example, the data processing unit 11 classifies and stores invoice data received by the invoice management apparatus 1, external communications (will be described later) and memos made by an accounting personnel, and others in appropriate storage units.

The invoice data storage unit 12 stores therein invoice data received by the invoice management apparatus 1, by accounting personnel (more specifically, by mail address of accounting personnel). The invoice data received by the invoice management apparatus 1 includes invoice data sent from accounting persons of billers to accounting persons of bill-to parties and invoice data drafted by the accounting persons (issuers) of the billers.

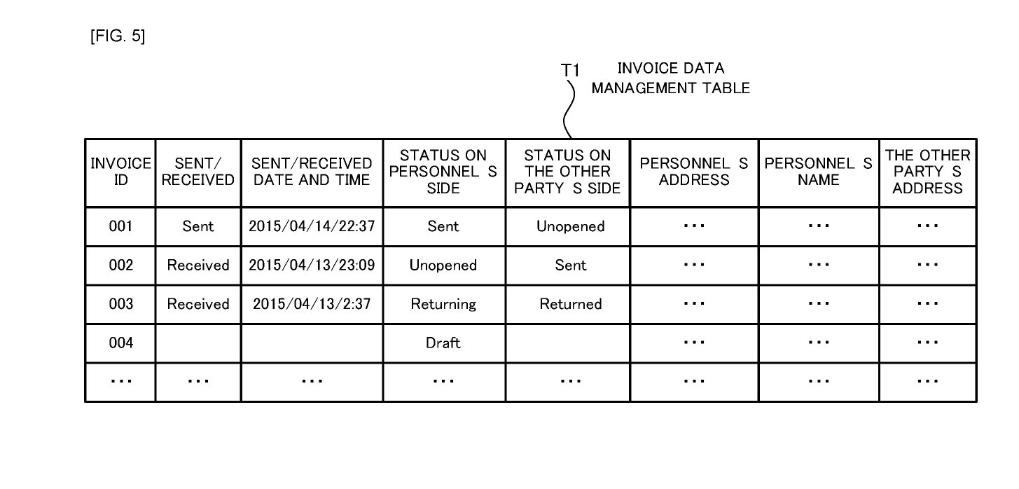

FIG. 5 is a view for explaining an example of invoice data.

In the present embodiment, data is stored in tabular form.

The invoice data management table T1 has the following columns: Invoice ID, Sent/Received, Sent/Received Date and Time, Status on Personnel's Side, Status on the Other Party's Side, Personnel's Address, Personnel's Name, and The Other Party's Address. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Address column contains the mail address of the accounting personnel.

The Personnel's Name column contains the department to which the accounting personal belongs and the name of the accounting personnel.

The Other Party's Address column contains the mail address of the accounting personnel of the other party that communicates the invoice data.

In addition to the above-described information, the invoice data management table contains information about the company name of the accounting personnel, the company name of the accounting personnel of the other party that communicates the invoice data, the postal codes and addresses of both companies, departments, and others.

(Management Screen)

The data processing unit 11 displays the management screen 110 illustrated in FIG. 2 on the terminal device 2a or the like in accordance with accounting personnel's operations.

The management screen 110 has a user information display area 111, a status display area 112, a summary display area 113, an invoice display area 114, an External Communication button 115, an Attached File button 116, a History button 117, a Memo button 118, an External Communication List display button 119, a Memo List display button 120, an information display area 121, and an information input area 122.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel.

The status display area 112 displays the number of pieces of invoice data that is handled by the accounting personnel that has logged in to the invoice management system, for each status.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel selects the Inbox folder, the data processing unit 11 refers to the invoice data management table T1. Then, the data processing unit 11 displays, in the summary display area 113, the summary of invoice data that has “Received” in the Sent/Received column, among invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the biller among the invoice data placed in the Inbox folder.

The “Deleted by the Other Party” status is given by the data processing unit 11 to invoice data that has been received, returned by the accounting personnel to the accounting personnel of the biller, and then deleted by the accounting personnel of the biller, among the invoice data placed in the Inbox folder.

The “Confirmed” status is given by the data processing unit 11 to invoice data which the accounting personnel has viewed and for which the accounting personnel has selected a Confirm button (will be described later), among the invoice data placed in the Inbox folder.

The “Paid” status is given by the data processing unit 11 to invoice data for which the accounting personnel has made payment and then selected a Payment button (not illustrated), among the invoice data placed in the Inbox folder.

The accounting personnel compiles the invoice data in the Paid status to confirm the details of the payment.

The “Archive” status is given by the data processing unit 11 to invoice data which the account personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the content of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel selects the Unopened status, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel selects the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process the invoice data returned from the bill-to party.

The “Deleted” status is given by the data processing unit 11 to invoice data that has been deleted by the accounting personnel of the biller, among the invoice data returned from the accounting personnel of the bill-to party.

The “Payment Received” status is given by the data processing unit 11 to invoice data for which the accounting personnel of the biller has confirmed payment and selected a Payment Received button (will be described later), among the invoice data placed in the Outbox folder.

The “Archive” status is given by the data processing unit 11 to invoice data which the accounting personnel has saved in the Archive at certain timing, among the invoice data in the “Payment Received” status.

The Archive status in the status display area 112 does not specifically indicate any number.

What is needed to view the content of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a biller, a case name, a payment date and time, a status on the sender side, and a status on the recipient side.

The same statuses are displayed on the management screens of both the accounting personnel who has sent invoice data and the accounting personnel who has received the invoice data.

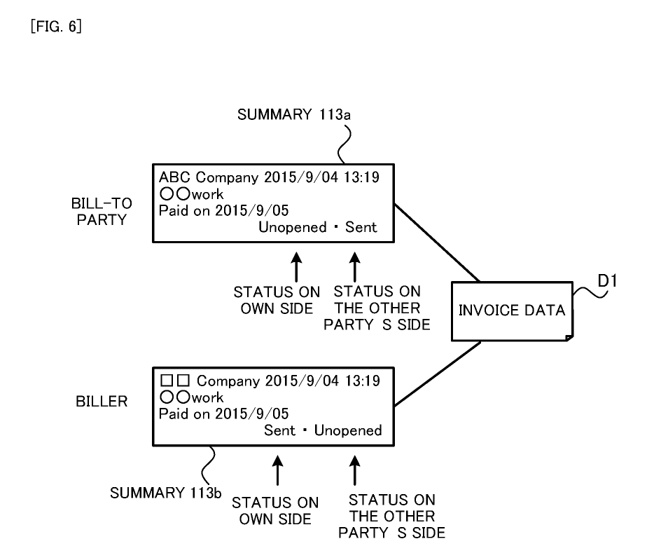

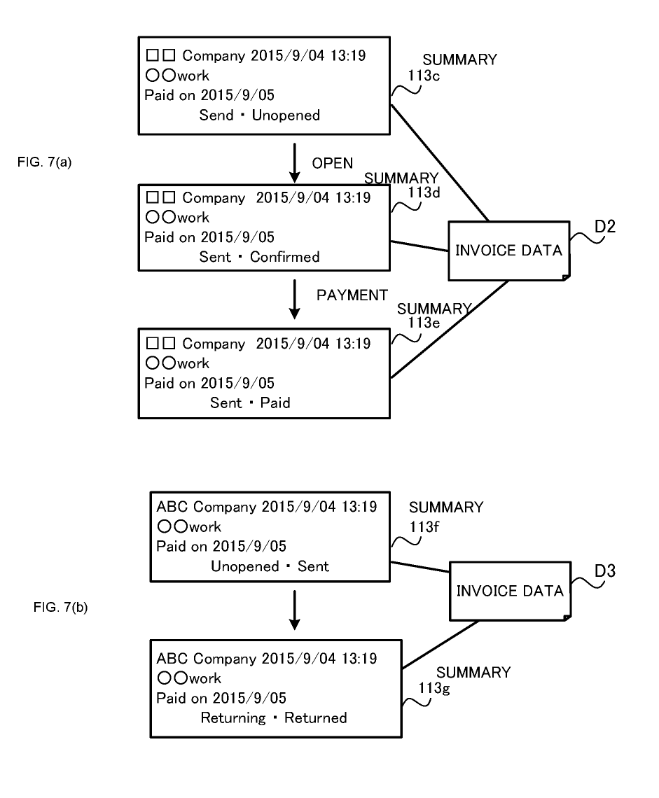

FIGS. 6, 7A, and 7B are views for explaining information to be displayed in the summary display area.

FIG. 6 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the biller.

More specifically, invoice data D1 with a biller of ABC company and a case name of OO work, as illustrated in FIG. 6, is in the “Sent” status in the status display area on the management screen of the terminal device operated by the accounting personnel of the biller. When the accounting personnel of the biller selects the “Sent” status in the status display area, the following information is displayed with respect to the invoice data D1 in the summary display area 113: a bill-to party is □□ company, a case name is OO work, a status on the accounting personnel's side of the biller is “Sent,” and a status on the accounting personnel's side of the bill-to party is “Unopened.”

By confirming status transitions, the accounting personnel of the biller is able to easily confirm the progress of processing made by the accounting personnel of the bill-to party. That is to say, the accounting persons of both parties are able to confirm the current status of each invoice data in real-time.

All summaries 113c, 113d, and 113e illustrated in FIG. 7A are of invoice data D2.

When the accounting personnel of the bill-to party has viewed the invoice data D2 and selected a Confirm button (will be described later), the data processing unit 11 changes information displayed in the summary display area 113 from the summary 113c to the summary 113d on the management screen 110 of the terminal device operated by the accounting personnel of the biller.

After that, when the accounting personnel of the bill-to party has made payment for the invoice data D2 and selected a Paid button (will be described later), the data processing unit 11 changes information displayed in the summary display area 113 from the summary 113d to the summary 113e on the management screen 110 of the terminal device operated by the accounting personnel of the biller.

As another example, both summaries 113f and 113g illustrated in FIG. 7B are of invoice data D3.

When the accounting personnel of the bill-to party has viewed the invoice data D3 and selected a Return button (will be described later), the data processing unit 11 changes information displayed in the summary display area 113 from the summary 113f to the summary 113g on the management screen of the terminal device operated by the accounting personnel of the bill-to party.

Refer now back to FIG. 2.

When the accounting personnel has selected the summary of invoice data being displayed in the summary display area 113, the data processing unit 11 displays the content of the invoice in the invoice display area 114. The content of the invoice to be displayed in the invoice display area 114 is the same as that of existing (paper-based or PDF-based) invoices, except that an address display area 114a and various buttons, which will be described later, are displayed.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons that are displayed when invoice data in the Unopened status is selected.

The invoice display area 114 includes a Confirm button 114b, a Return button 114c, and a Copy button 114d.

When the accounting personnel selects the Confirm button 114b, the data processing unit 11 refers to the invoice data management table T1. The data processing unit 11 then changes the Status on Personnel's Side column to “confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel selects the Return button 114c, the data processing unit 11 refers to the invoice data management table T1. The data processing unit 11 then changes the Status on Personnel's Side column to “returning” with respect to the invoice data being displayed in the invoice display area 114, and then changes the Status on the Other Party's Side column to “returned”. In addition, the data processing unit 11 decreases the number for the “Unopened” status by one and increases the number for the “Returning” status by one in the status display area 112.

On the management screen of the accounting personnel who has received the returned invoice data, the number for the Returned status in the status display area is increased by one.

When the accounting personnel selects the Copy button 114d, the data processing unit 11 creates new invoice data by replacing the company name and address between the biller and the bill-to party in the invoice data. Then, the data processing unit 11 stores information on the created invoice data in the invoice data management table T1. At this time, with respect to the invoice data, “Draft” is set in the Status on Personnel's Side column and a blank is set in the Status on the Other Party's Side column.

(Returns Processing)

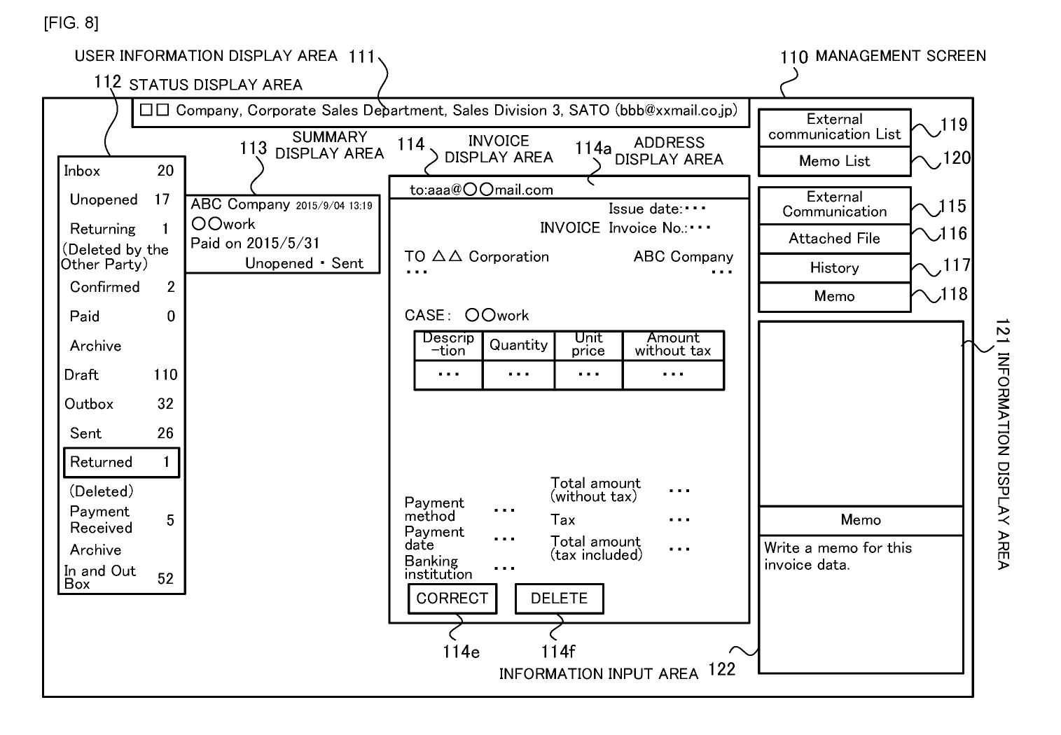

FIG. 8 is a view for explaining how to process returned invoice data.

When the accounting personnel selects the Returned status and then selects the summary of an invoice being displayed in the summary display area 113, the data processing unit 11 displays invoice data corresponding to the selected summary of the invoice in the invoice display area 114. In this case, the mail address of the accounting personnel of the bill-to party is displayed in the address display area 114a.

The invoice display area 114 includes a Correct button 114e and a Delete button 114f.

When the accounting personnel selects the Correct button 114e, the data processing unit 11 changes the status of the invoice data being displayed in the invoice display area 114 to “Deleted”. In addition, the data processing unit 11 decreases the number for the “Returned” status by one in the status display area 112, and increases the number for the “Sent” status. Then, this information is added as a history.

When the accounting personnel selects the Delete button 114f, the data processing unit 11 changes the status of the invoice data being displayed in the invoice display area 114 to “Deleted”. Thereby, the numbers for the “Outbox” folder and “Returned” status are each decreased by one in the status display area 112.

In this connection, the accounting personnel of the biller and the accounting personnel of the bill-to party are able to view invoice data even after the invoice data is deleted.

More specifically, by selecting the “Deleted” status in the status display area 112, the accounting personnel of the biller is able to view deleted invoice data. On the other hand, by selecting the “Deleted by the Other Party” status in the status display area 112, the accounting personnel of the bill-to party is able to view deleted invoice data.

Refer now back to FIG. 2.

Among all invoice data placed in the Inbox and Outbox folders, data other than deleted invoice data, invoice data saved in the archive, and invoice data in the Draft status is placed in the In and Out Box folder.

(External Communication Button)

When the accounting personnel selects the External Communication button 115, the data processing unit 11 switches the management screen 110 into an external communication input mode. In this external communication input mode, when the accounting personnel enters text (text data) in the information input area 122 and presses the enter key of a keyboard or the like to fix this operation, the data processing unit 11 stores, as an external communication, the text data in the external communication data storage unit 13 in association with the mail address of the accounting personnel and the invoice data being displayed in the invoice display area 114.

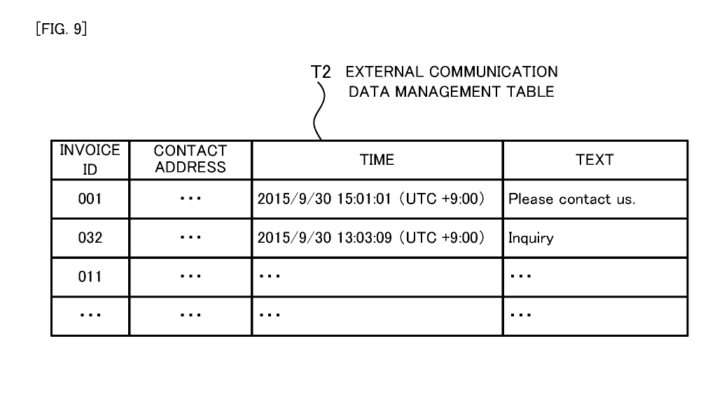

FIG. 9 is a view for explaining an example of external communication data.

In the present embodiment, external communication data is stored in tabular form.

An external communication data management table T2 has the following columns: Invoice ID, Contact Address, Time, and Text. Information pieces arranged in a horizontal direction are associated with each other.

The Invoice ID column contains the invoice ID of invoice data (invoice data associated with external communication data) that was displayed in the invoice display area 114 when the accounting personnel created the external communication data.

The Contact Address column contains the mail address of a creator that has created the external communication data.

The Time column contains the creation date and time of the external communication data.

The Text column contains the content of the external communication.

In addition, in the external communication input mode, the data processing unit 11 refers to the external communication data management table T2 with respect to the invoice data being displayed in the invoice display area 114, and displays the external communications created so far, together with the creation dates and times in chronological order in the information display area 121.

The information display area 121 displays external communications entered by the accounting persons of both the sender and the recipient of the invoice data. Therefore, this external communication input mode enables these accounting persons to perform communications like chats with each other.

In this connection, other processing (downloading, conversion to PDF format, and others) performed by the accounting persons on the invoice data being displayed in the invoice data display area 114 may be indicated in the information display area 121 together with the execution dates and times of the processing. This enables both the accounting persons to know the history on each other's processing.

(Attached File Button)

When the accounting personnel selects the Attached File button 116, the data processing unit 11 switches the management screen 110 into an attached file mode. In this attached file mode, when the accounting personnel clicks and drags attached data into the information input area 122 and presses the enter key of the keyboard or the like to fix this operation, the data processing unit 11 stores the attached data in the attached file data storage unit 14 in association with the mail address of the accounting personnel and the invoice data being displayed in the invoice display area 114.

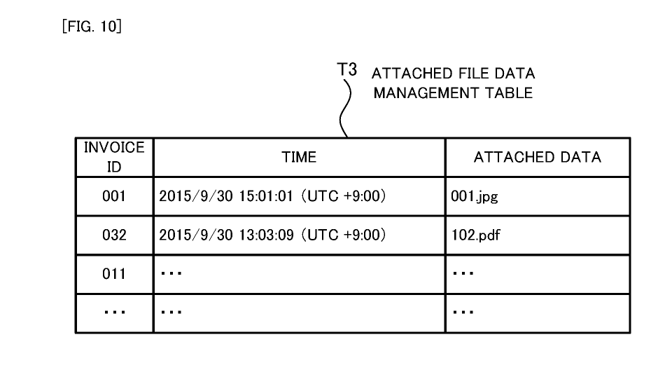

FIG. 10 is a view for explaining an example of attached file data.

In the present embodiment, attached file data is stored in tabular form.

An attached file data management table T3 has the following columns: Invoice ID, Time, and Attached Data. Information pieces arranged in a horizontal direction are associated with each other.

The Invoice ID column contains the invoice ID of invoice data (invoice data associated with attached data) that was displayed on a screen when the attached data was attached.

The Time column contains the attached date and time of the attached data.

The Attached Data column contains the name of the attached data.

In a file mode, the data processing unit 11 refers to the attached file data management table T3 with respect to invoice data being displayed in the invoice display area 114, and displays information about attached files attached so far, in chronological order in the information display area 121.

(History Button)

The data processing unit 11 stores a history on operations made so far by the accounting persons of both parties in the history data storage unit 15.

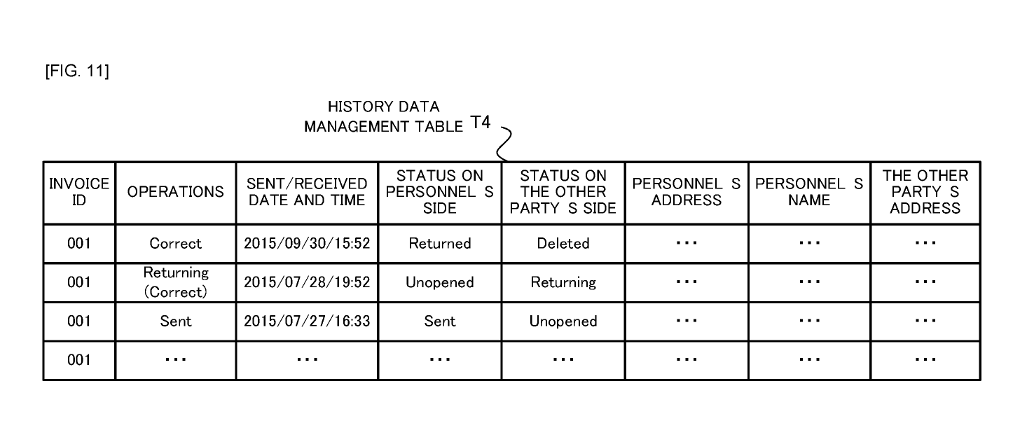

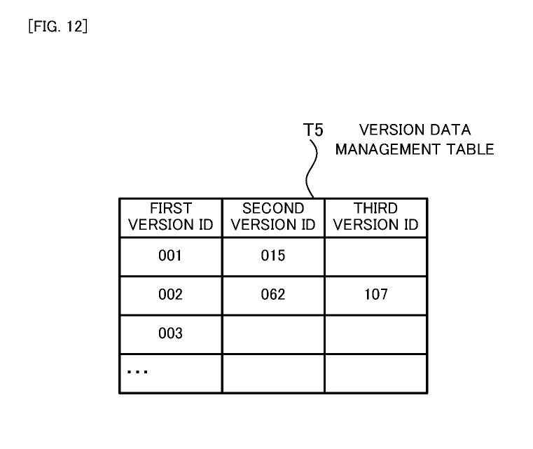

FIGS. 11 and 12 are views for explaining an example of data stored in the history data storage unit.

In the present embodiment, data is stored in tabular form.

The data processing unit 11 creates a history data management table T4 for each invoice data. In this connection, a different history data management table T4 is created for a different version.

The history data management table T4 has the following columns: Invoice ID, Operations, Send/Received Date and Time, Status on Personnel's Side, Status on the Other Party's Side, Personnel's Address, Personnel's Name, and The Other Party's Address. Information pieces arranged in a horizontal direction are associated with each other.

The Operations column contains an operation made by the accounting personnel. The other columns have the same content as those of the invoice data management table T1, and therefore the description of these columns will not be repeated.

As illustrated in FIG. 12, a version data management table T5 has the following columns: First Version ID, Second Version ID, and Third Version ID. Information pieces arranged in a horizontal direction are associated with each other.

The First Version ID column contains an invoice ID that was given by the data processing unit 11 when the accounting personnel created invoice data and selected a Save button (not illustrated) on the management screen 110.

The Second Version ID column contains an invoice ID that was given by the data processing unit 11 when the accounting personnel created a second version based on the invoice data with the first version ID and selected the Save button (not illustrated) on the management screen 110.

The Third Version ID column contains an invoice ID that was given by the data processing unit 11 when the accounting personnel created a third version based on the invoice data with the second version ID and selected the Save button (not illustrated) on the management screen 110.

FIG. 12 illustrates columns up to the third version. If a fourth version of the invoice data is created, the data processing unit 11 adds an invoice ID of the created invoice data to a column of the version data management table T5. The same operation is performed for the fifth and subsequent versions.

When the accounting personnel selects the History button 117, the data processing unit 11 switches the management screen 110 to a history display mode. More specifically, the data processing unit 11 refers to the history data management table T4 and the version data management table T5, and displays a history about transactions of the invoice data being displayed in the invoice display area 114, in chronological order in the information display area 121.

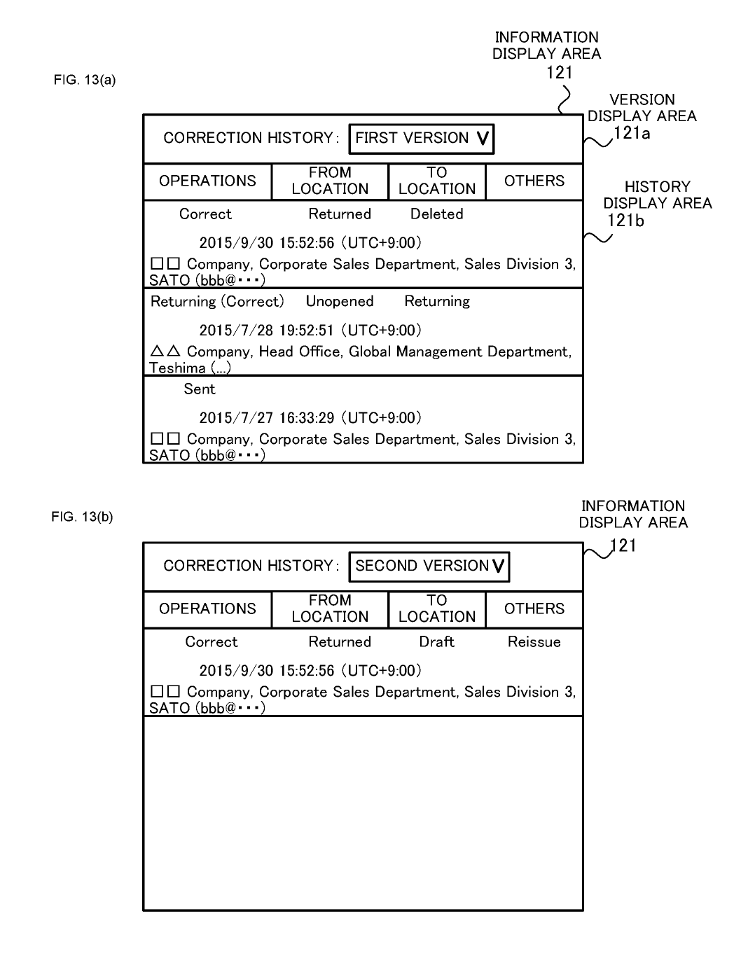

FIGS. 13A and 13B are views for explaining examples of data to be displayed in the information display area in the history display mode.

The information display area 121 has a version display area 121a for displaying a version of invoice data and a history display area 121b for displaying a history about transactions of the invoice data.

The data processing unit 11 refers to the history data management table T4 and displays transactions of invoice data in chronological order in the history display area 121b. Referring to the example of FIG. 13A, the following transactions are displayed: the invoice data being displayed in the invoice display area 114 was created and sent by SATO, who is a sender accounting personnel; the invoice data was returned by TESHIMA, who is a recipient accounting personnel; the invoice data was corrected by SATO to thereby create a second version of the invoice data; and the first version of the invoice data was deleted by SATO.

In addition, when the accounting personnel selects another version, the data processing unit 11 refers to the version data management table T5 to identify the invoice data in question. In the example of FIG. 12, for example, if the invoice ID corresponding to the first version of invoice data is “001” and the accounting personnel selects the second version of the invoice data, the data processing unit 11 identifies invoice data with an invoice ID of “015”. Then, the data processing unit 11 refers to the history data management table T4 to display transactions of the invoice data in chronological order in the history display area 121b. In the example of FIG. 13B, the following transaction is displayed: Sato is drafting a second version of the invoice data.

(Memo Button)

When the accounting personnel selects the Memo button 118, the data processing unit 11 switches the management screen 110 into a memo input mode. In this memo input mode, when the accounting personnel enters letters and so on in the information input area 122 and presses the enter key of the keyboard or the like to fix this operation, the data processing unit 11 stores the letters and so on as a memo in association with the mail address of the accounting personnel and the invoice data being displayed in the invoice display area 114 in the memo data storage unit 16. This memo is viewable only by the person who created the memo.

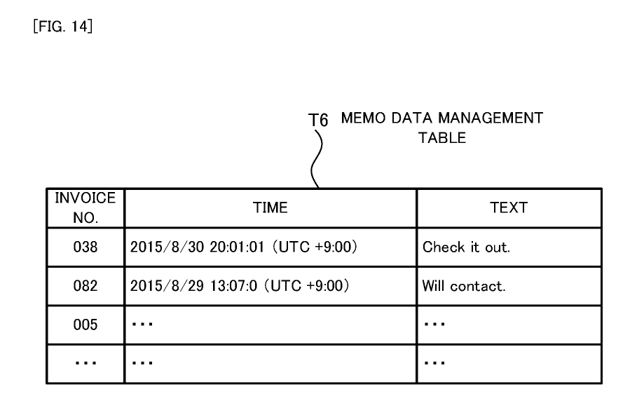

FIG. 14 is a view for explaining an example of memo data.

In the present embodiment, memo data is stored in tabular form.

A memo data management table T6 has the following columns: Invoice ID, Time, and Text. Information pieces arranged in a horizontal direction are associated with each other.

The Invoice ID column contains the invoice ID of invoice data (invoice data associated with a memo) that was displayed on a screen when the accounting personnel created the memo.

The Time column contains the creation date and time of the memo data.

The Text column contains the content of the memo.

In addition, in the memo input mode, the data processing unit 11 refers to the memo data storage unit 16 to display memos created so far about invoice data being displayed in the invoice display area 114 in chronological order in the information display area 121.

(External Communication List Display Button)

When the accounting personnel selects the External Communication List display button 119, the data processing unit 11 refers to the external communication data storage unit 13 storing therein data about external communications, and displays a list screen (external communication list screen) regarding external communications about invoices handled by the accounting personnel in chronological order on the management screen 110.

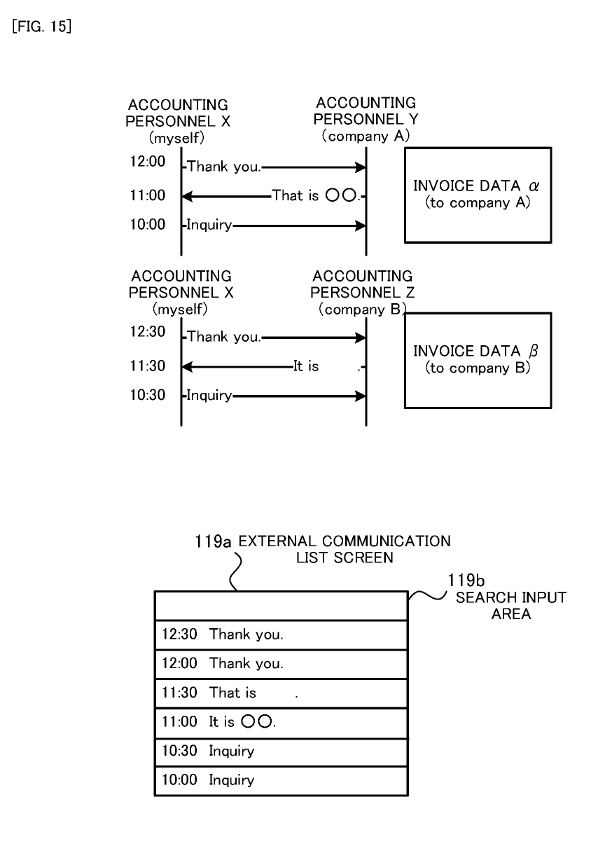

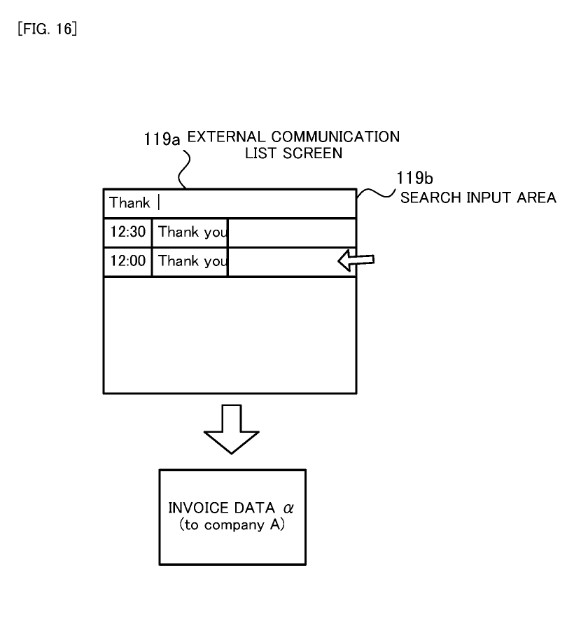

FIGS. 15 and 16 are views for explaining an example of an external communication list.

As illustrated in FIG. 15, assume that an accounting personnel X made external communications with an accounting personnel Y with regard to invoice data α at 10:00, 11:00, and 12:00 on the same day, and the accounting personnel X makes external communications with an accounting personnel Z with regard to invoice data β at 10:30, 11:30, and 12:30 on the same day.

In this case, an external communication list screen 119a as illustrated in FIG. 15 is displayed on the management screen of the terminal device operated by the accounting personnel X. This external communication list screen 119a displays a log about external communications with other accounting persons in chronological order, not for each invoice data.

This external communication list screen 119a has a search input area 119b. When the accounting personnel X enters a search word and presses an enter key (search request), the data processing unit 11 identifies external communications including a text matching the search word.

For example, as illustrated in FIG. 16, when the accounting personnel X enters “Thank you” in the search input area 119b and presses the enter key, the data processing unit 11 displays “Thank you” at 12:00 and “Thank you” at 12:30 as a search result. For example, when the accounting personnel X selects and clicks on “Thank you” at 12:00, the data processing unit 11 displays the content of invoice data α associated with the external communication data including the text in question, in the invoice display area 114.

In this way, it is possible to easily find invoice data on the basis of terms used in external communications.

In this connection, without entering a search word in the search input area 119b, the accounting personnel may directly click on a desired text on the external communication list screen 119a. This operation also causes the data processing unit 11 to display the content of invoice data associated with external communication data including the text in question in the invoice display area 114.

The following describes how the data processing unit operates to find invoice data.

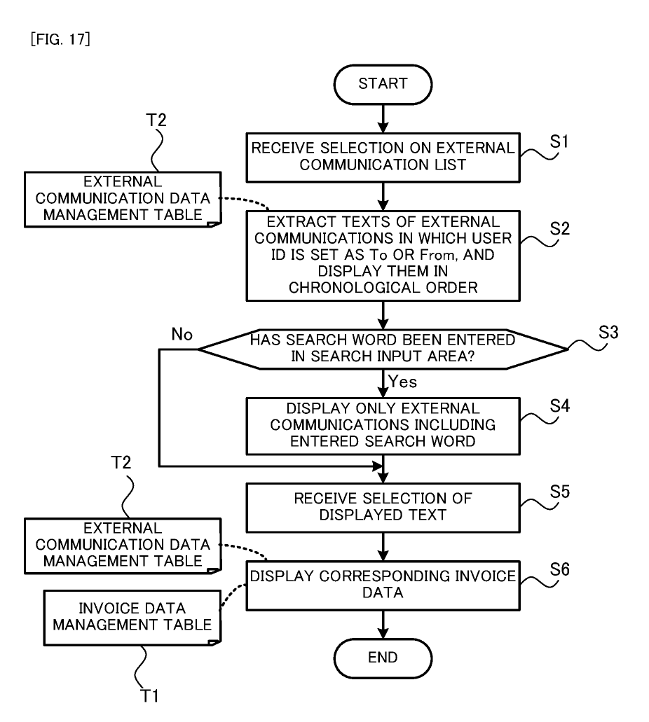

FIG. 17 is a flowchart for explaining how the data processing unit operates to find invoice data.

(Step S1) When the data processing unit 11 receives selection of the External Communication List display button 119, the process proceeds to step S2.

(Step S2) The data processing unit 11 refers to the external communication data management table T2. The data processing unit 11 extracts all external communication data with respect to an accounting personnel who is indicated in the user information display area 111 and whose mail address is stored in the Contact Address column. Then, the data processing unit displays the texts of the extracted external communication data in chronological order in the external communication list screen 119a. Then, the process proceeds to step S3.

(Step S3) The data processing unit 11 determines whether a search word has been entered in the search input area 119b. If the search word has been entered (Yes at step S3), the process proceeds to step S4. If no search word has been entered (No at step S3), the process proceeds to step S5.

(Step S4) The data processing unit 11 displays only external communications including the entered search word in the external communication list screen 119a.

(Step S5) When the data processing unit 11 receives selection of a text being displayed, the process proceeds to step S6.

(Step S6) The data processing unit 11 refers to the external communication data management table T2, and identifies an invoice ID of external communication data including the text. The data processing unit 11 then refers to the invoice data management table T1 and displays the content of invoice data whose invoice ID matches the identified invoice ID in the invoice display area 114.

FIG. 17 has been described.

Refer now back to FIG. 2. When the accounting personnel selects the Memo List display button 120, the data processing unit 11 refers to the memo data storage unit 16 storing therein data on external communications, to display a list screen (memo list screen) of memos regarding invoices handled by the accounting personnel in chronological order on the management screen 110.

As described earlier, in the invoice management system 10, invoice data is not communicated directly between the terminal devices 2a, 2b, and 2c. The invoice data created using the terminal devices 2a, 2b, and 2c and sent to bill-to parties is held by the invoice management apparatus 1 and is treated like shared data. Therefore, the accounting personnel of a bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

The information display area 121 displays external communications made by the accounting persons of both the sender and the recipient of invoice data. Therefore, using the external communication input mode enables the accounting persons of both parties to perform communications like chats.

Information on invoice data is stored in the invoice data management table T1 when the invoice data is sent, and the statuses of subsequent transactions are managed using this invoice data management table T1.

Therefore, the accounting personnel is able to get away from manually compiling invoices into a data sheet.

### Second Embodiment

The following describes an invoice management system according to a second embodiment.

Hereinafter, with regard to the invoice management system of the second embodiment, differences from the above-described first embodiment will mainly be described, and the same or substantially the same features as the first embodiment will not be described again.

The invoice management system of the second embodiment is different from that of the first embodiment in that a terminal device 2a is a portable terminal device, such as a smartphone or a tablet.

In the following description, the terminal device 2a is referred to as “portable terminal device 2a.”

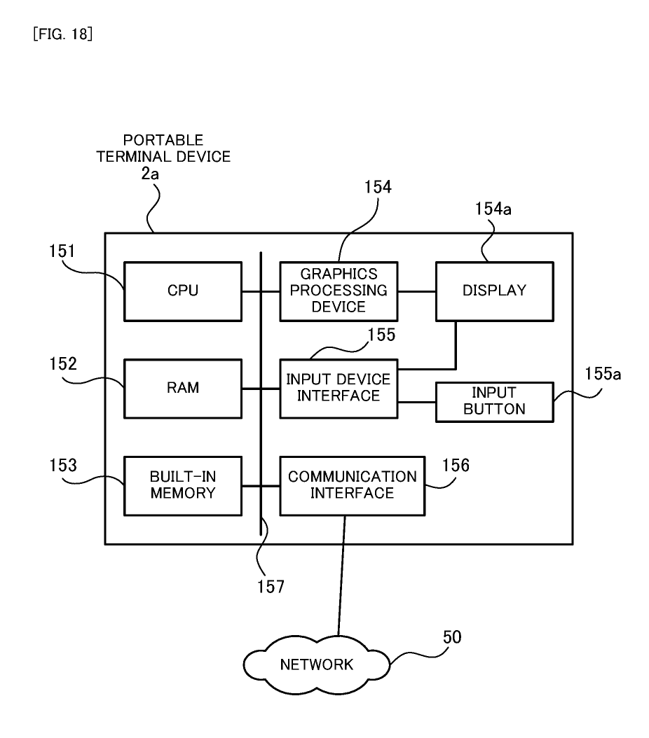

FIG. 18 is a view for explaining a hardware configuration of a portable terminal device according to the second embodiment.

The portable terminal device 2a is entirely controlled by a CPU (central processing unit) 151.

A RAM (random access memory) 152 and a plurality of peripheral devices are connected to the CPU 151 via a bus 157.

The RAM 152 is used as a main storage device of the portable terminal device 2a. The RAM 152 temporarily stores at least part of OS (operating system) programs and application programs to be executed by the CPU 151. In addition, the RAM 152 stores therein various data to be used by the CPU 151 in processing.

A built-in memory 153, a graphics processing device 154, an input device interface 155, and a communication interface 156 are connected to the bus 157.

The built-in memory 153 performs data read and write. The built-in memory 153 is used as an auxiliary storage device of the portable terminal device 2a. The built-in memory 153 stores OS programs, application programs, and various data. In this connection, as the built-in memory, a flash memory or another semiconductor storage device may be used, for example.

A display 154a is connected to the graphics processing device 154. The graphics processing device 154 displays images on the screen of the display 154a in accordance with instructions from the CPU 151. As the display 154a, a liquid crystal display device or the like may be used. In addition, the display 154a has a touch-panel function.

The display 154a and an input button 155a are connected to the input device interface 155. The input device interface 155 transfers signals received from the input button 155a and the touch panel of the display 154a to the CPU 151.

The communication interface 156 is connected to a network 50. The communication interface 156 communicates data with a computer such as an invoice management apparatus or a communication device over the network 50.

The processing functions of this embodiment are implemented by using the above-described hardware configuration.

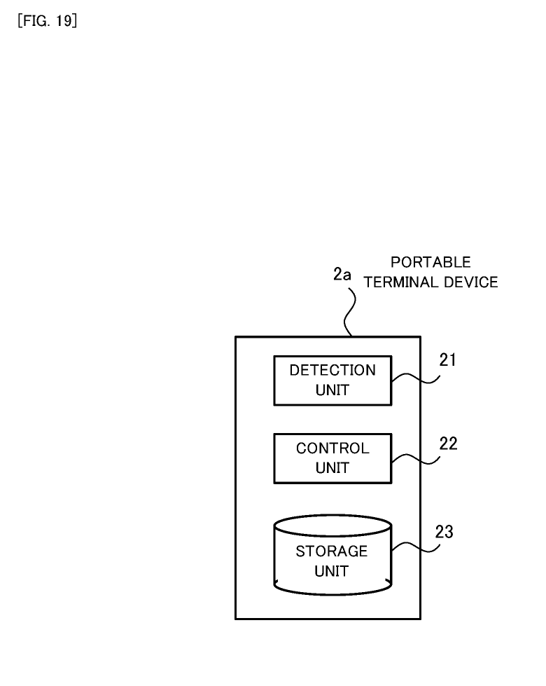

FIG. 19 is a block diagram illustrating functions of the portable terminal device according to the second embodiment.

The portable terminal device 2a includes a detection unit 21, a control unit 22, and a storage unit 23.

The detection unit 21 detects a screen switching operation (an operation to switch a certain screen to another) performed on the display 154a by an accounting personnel. Examples of the screen switching operation include a tapping (selecting) operation on the display 154a, a swiping (sliding) operation on the display 154a, or another operation.

The control unit 22 controls data communication with an invoice management apparatus 1a.

In addition, the control unit 22 display various screens, to be described later, on the display 154a with reference to the storage unit 23.

The storage unit 23 stores temporary data to be used for the portable terminal device 2a to communicate with the invoice management apparatus 1a, data to be displayed on the display 154a, and others.

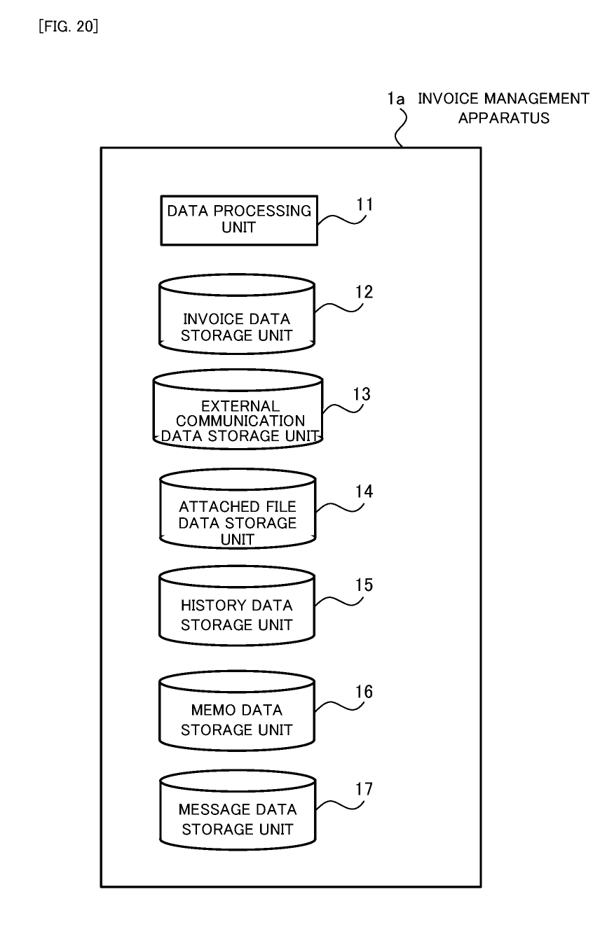

FIG. 20 is a block diagram illustrating functions of the invoice management apparatus according to the second embodiment.

The invoice management apparatus 1a of the second embodiment additionally includes a message data storage unit 17.

The message data storage unit 17 stores therein a history of messages exchanged between accounting persons in association with the mail addresses of both the accounting persons.

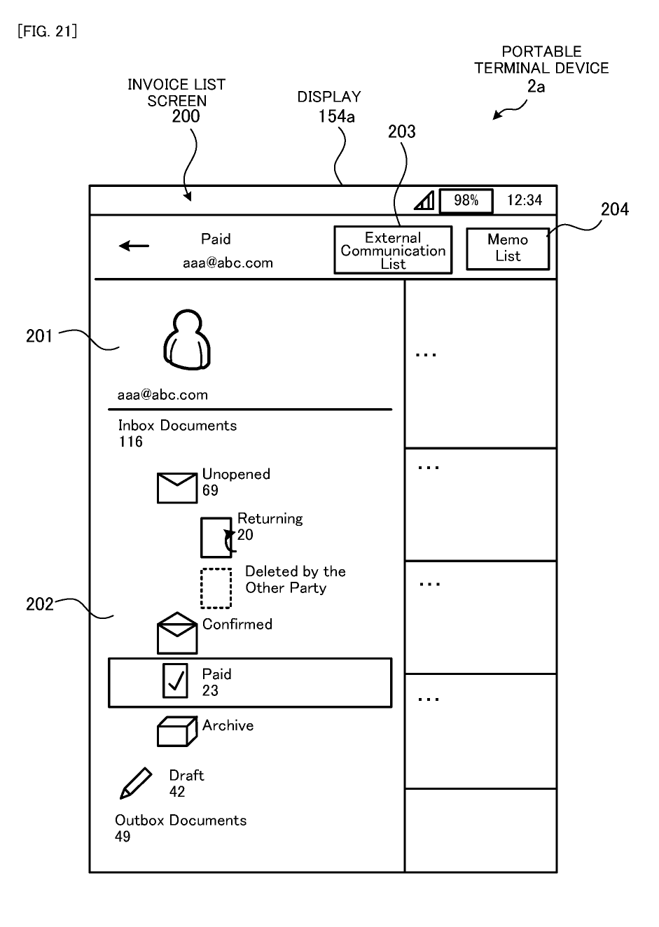

FIG. 21 is a view for explaining an invoice list screen that is displayed on the portable terminal device after a login.

The invoice list screen 200 has a user information display area 201, a status display area 202, an External Communication List display button 203, and a Memo List display button 204.

The content displayed in the user information display area 201 is substantially the same as that displayed in the user information display area 111. It goes without saying that the department of an accounting personnel may be displayed in the user information display area 201 although it is not displayed in the user information display area 201 in FIG. 21.

The content displayed in the status display area 202 is substantially the same as that displayed in the status display area 112. FIG. 21 illustrates a situation where the accounting personnel is viewing invoice data placed in “Paid” status.

The functions of the External Communication List display button 203 and Memo List display button 204 are substantially the same as those of the External Communication List display button 119 and Memo List display button 120, respectively. That is, when the detection unit 21 detects that the accounting personnel has tapped the External Communication List display button 203, the control unit 22 sends a display request for an external communication list regarding invoice data to the invoice management apparatus 1a. The invoice management apparatus 1a sends the external communication list regarding corresponding invoice data to the portable terminal device 2a, on the basis of the invoice IDs of the invoice data. The control unit 22 displays the received external communication list on the display 154a.

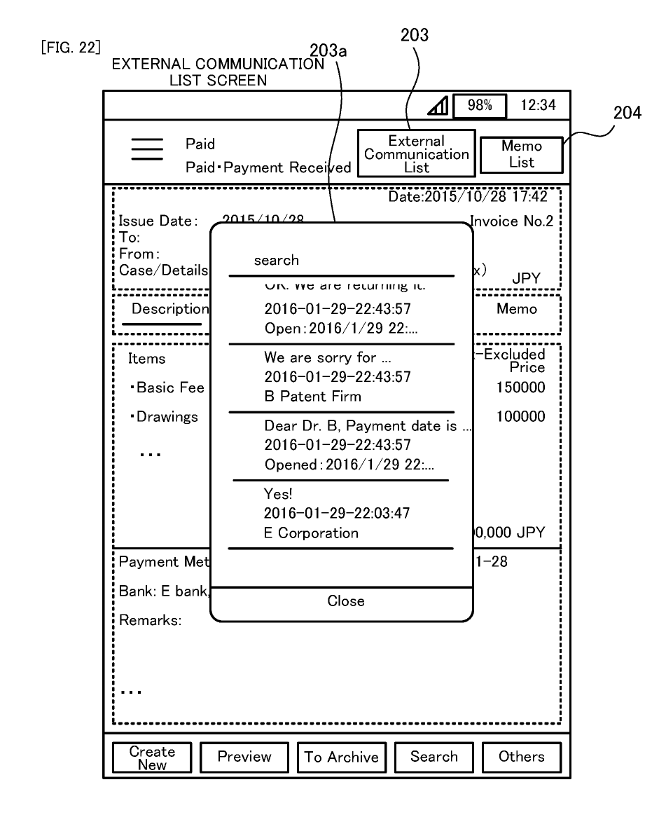

FIG. 22 illustrates an example of a screen that is displayed on the portable terminal device when the External Communication List display button is tapped, according to the second embodiment. The control unit 22 displays an external communication list screen 203a on top of the other currently displayed screens.

When the detection unit 21 detects that the accounting personnel has tapped the Memo List display button 204, the control unit 22 sends a display request for memo data regarding invoice data to the invoice management apparatus 1a. The invoice management apparatus 1a sends the memo data regarding corresponding invoice data to the portable terminal device 2a, on the basis of the invoice IDs of the invoice data. The control unit 22 displays the received memo data on the display 154a.

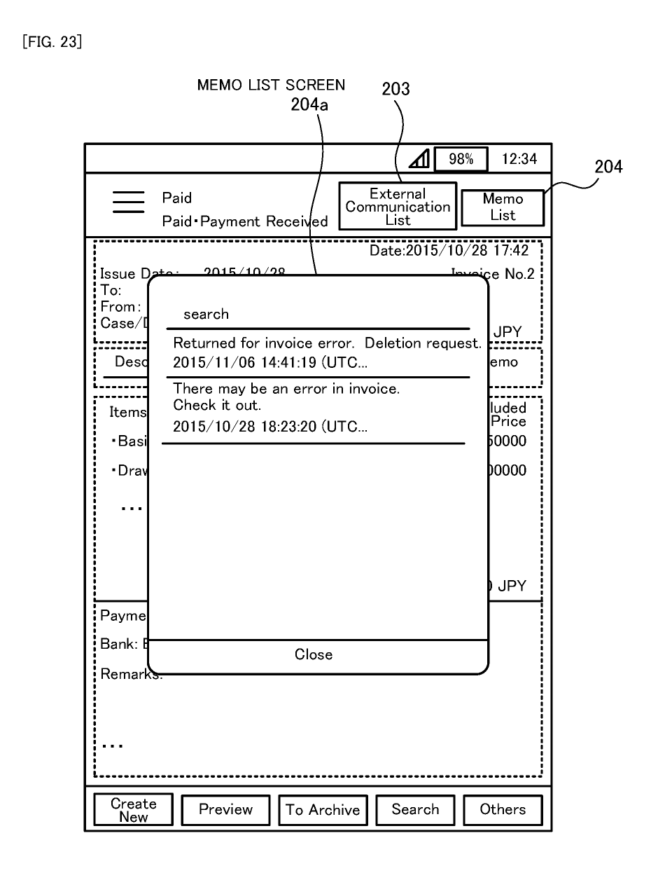

FIG. 23 illustrates an example of a screen that is displayed on the portable terminal device when the Memo List display button is tapped, according to the second embodiment. The control unit 22 displays a memo list screen 204a on top of the other currently displayed screens.

Refer now back to FIG. 21.

When the detection unit 21 detects that the accounting personnel has tapped a Paid icon displayed in the status display area 202, the control unit 22 sends a display request for a summary list regarding invoice data in the Paid status, to the invoice management apparatus 1a. The invoice management apparatus 1a refers to corresponding invoice data, and sends a summary list regarding the invoice data to the portable terminal device 2a. The control unit 22 displays the received summary list on the display 154a.

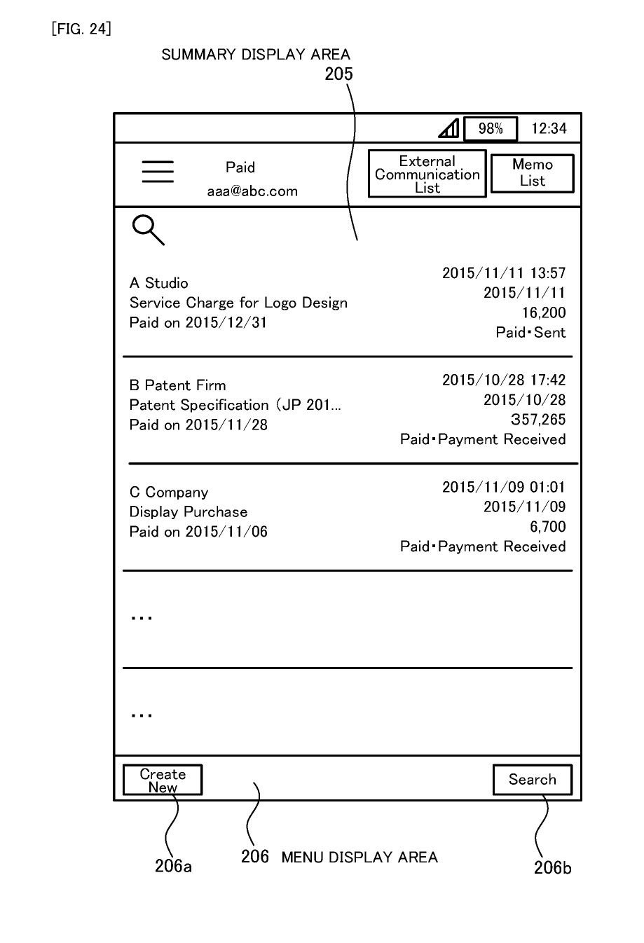

FIG. 24 is a view for explaining a summary of invoice data to be displayed on the display of the portable terminal device.

Information displayed in a summary display area 205 has content similar to that displayed in the summary display area 113.

In addition, a menu display area 206 is displayed below the summary display area 205.

The menu display area 206 has a Create New button 206a and a Search button 206b.

When the detection unit 21 detects that the accounting personnel has tapped the Create New button 206a, the control unit 22 displays a new creation screen (not illustrated) for invoice data on the display 154a. This enables the accounting personnel to create invoice data by operating the portable terminal device 2a. In this connection, how to create invoice data will be described later.

When the accounting personnel selects the Search button 206b, the control unit 22 displays the summary display area 205 of FIG. 24 on the display 154a.

When the detection unit 21 detects that the accounting personnel has tapped any of the summary records of invoice data displayed in the summary display area 205, the control unit 22 sends a detail display request for the invoice data in question to the invoice management apparatus 1a. The invoice management apparatus 1a refers to the invoice data in question, and sends detailed data on the invoice data to the portable terminal device 2a. Upon receipt of the detailed data, the control unit 22 displays the received detailed data on the display 154a.

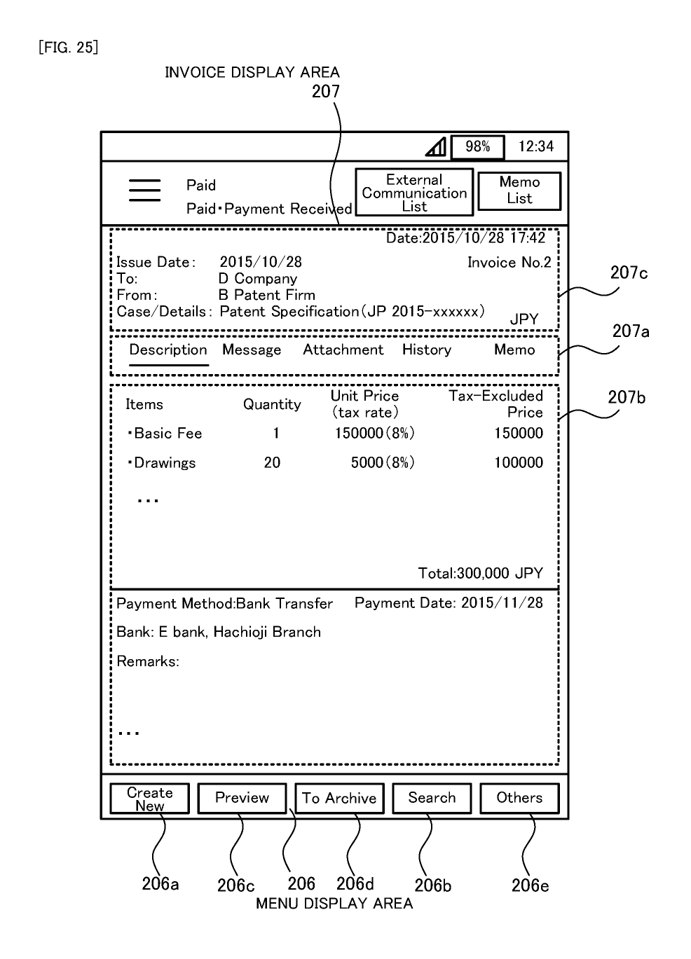

FIG. 25 is a view for explaining detailed data to be displayed on the display of the portable terminal device.

An invoice display area 207 has a first screen 207a, a second screen 207b, and a third screen 207c. In this connection, in FIG. 25, broken lines are displayed to distinguish the areas of the first screen 207a, second screen 207b, and third screen 207c, but the broken lines are not needed.

The first screen 207a displays a plurality of category names of categories into which the content of invoice data is classified, in a row. More specifically, the first screen 207a displays the following categories: Description, Message, Attachment, History, and Memo. In addition, the first screen 207a displays identifying information (an underline in the present embodiment) to emphasize a currently selected category among the categories. In FIG. 25, an underline is added to the category name “Description”.

The second screen 207b displays data corresponding to each category displayed on the first screen 207a among data related to invoice data. In this connection, the data related to the invoice data includes data associated with the invoice data, as well as the content of the invoice data itself.

In FIG. 25, data corresponding to “Description” out of the invoice data, which relates to invoice description (breakdown), is displayed. Note that, when the detection unit 21 detects that the accounting personnel has tapped the Create New button 206a, the control unit 22 performs the above-described process to display a (blank) input screen, with no content displayed, for entering the description of an invoice on the second screen 207b.

The third screen 207c displays data (header detailed data) identifying the invoice data (i.e., data unique to the invoice data), such as issue date, recipient, issuer, and case name, out of the invoice data.

In addition, when the invoice display area 207 is displayed on the display 154a, the control unit 22 additionally displays a Preview button 206c, a button 206d for status change, and an Others button 206e in the menu display area 206.

When the detection unit 21 detects that the accounting personnel has tapped the Preview button 206c, the control unit 22 displays a preview screen of a PDF file indicating an invoice, history, external communications, and memos as one file, in the invoice display area 207.

When the detection unit 21 detects that the accounting personnel has tapped the button 206d for status change, the control unit 22 notifies the invoice management apparatus 1a that the invoice data of the invoice being displayed in the invoice display area 207 is to be moved to an archive. The invoice management apparatus 1a refers to the invoice data in question, and gives an “Archive” status to the invoice data. At this time, the control unit 22 displays detailed data about the invoice data of another summary record (a summary record placed below the archived one, for example) being displayed in the summary display unit 205, in the invoice display area 207.

By the way, the button name of the button 206d for status change is changed according to the status of invoice data being displayed in the invoice display area 207. For example, if invoice data being displayed in the invoice display area 207 is in the “Unopened” status, the button name of the button 206d for status change is “Confirmed”. In this case, when the detection unit 21 detects that the accounting personnel has tapped the button 206d for status change, the invoice management apparatus 1a refers to the invoice data in question, and gives a “Confirmed” status to the invoice data.

When the detection unit 21 detects that the accounting personnel has tapped the Others button 206e, the control unit 22 displays a screen for giving a status other than the Archive status to the invoice data of the invoice being displayed in the invoice display area 207, on the display 154a.

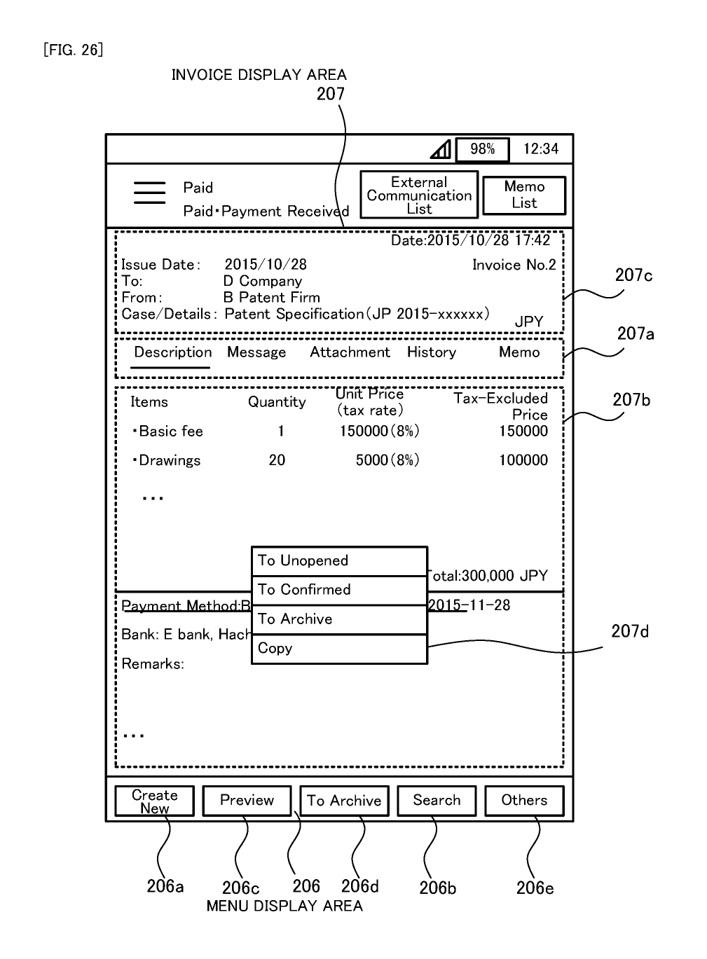

FIG. 26 is a view for explaining a screen for giving a status.

The invoice display area 207 displays a status selection screen 207d that enables giving an Unopened or Confirmed status to the invoice data of an invoice being displayed in the invoice display area 207. For example, when the accounting personnel taps “To Unopened” in the status selection screen 207d, the control unit 22 notifies the invoice management apparatus 1a that the invoice data of the invoice being displayed in the invoice display area 207 is to be set unopened. The invoice management apparatus 1a refers to the invoice data in question, and gives the “Unopened” status to the invoice data.

When the detection unit 21 detects that the accounting personnel has tapped the third screen 207c, the control unit 22 sends a display request for header detailed data to the invoice management apparatus 1a. The invoice management apparatus 1a refers to the invoice data in question, and sends the header detailed data about the invoice data to the portable terminal device 2a. Upon receipt of the header detailed data, the control unit 22 displays the header detailed data on the display 154a.

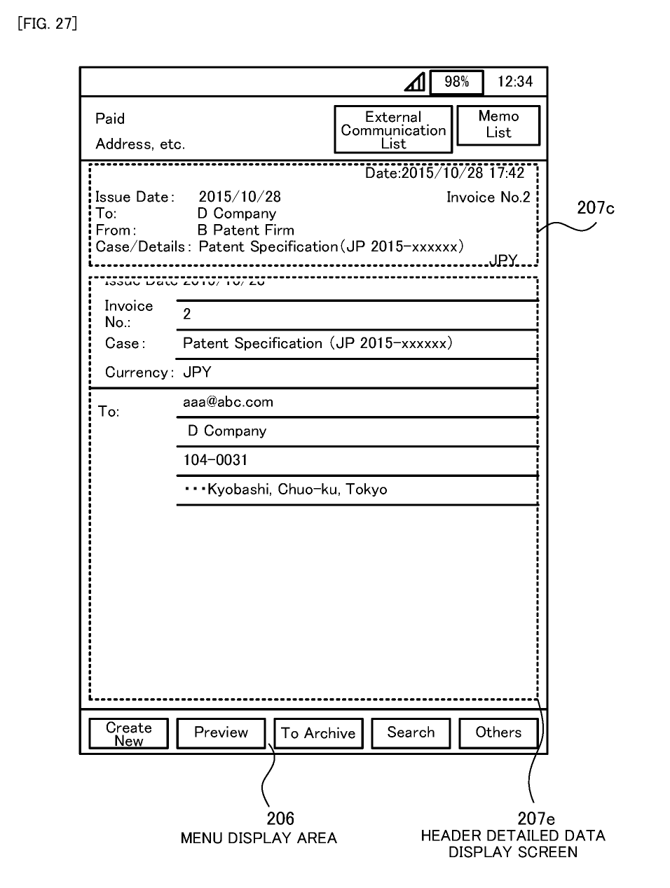

FIG. 27 is a view for explaining a header detailed data display screen that is displayed on the display of the portable terminal device.

The control unit 22 displays a header detailed data display screen 207e on the display 154a, in place of the first screen 207a and second screen 207b, while keeping the third screen 207c displayed.

The header detailed data display screen 207e displays data including the company name, address and others of the accounting personnel linked with the mail address of the recipient.

Refer now back to FIG. 25.

When the detection unit 21 detects that the accounting personnel has tapped an item in the Description category on the second screen 207b, the control unit 22 sends a display request for description detailed data to the invoice management apparatus 1a. The invoice management apparatus 1a refers to the invoice data in question, and sends the description detailed data about the invoice data to the portable terminal device 2a. Upon receipt of the description detailed data, the control unit 22 displays the description detailed data on the display 154a.

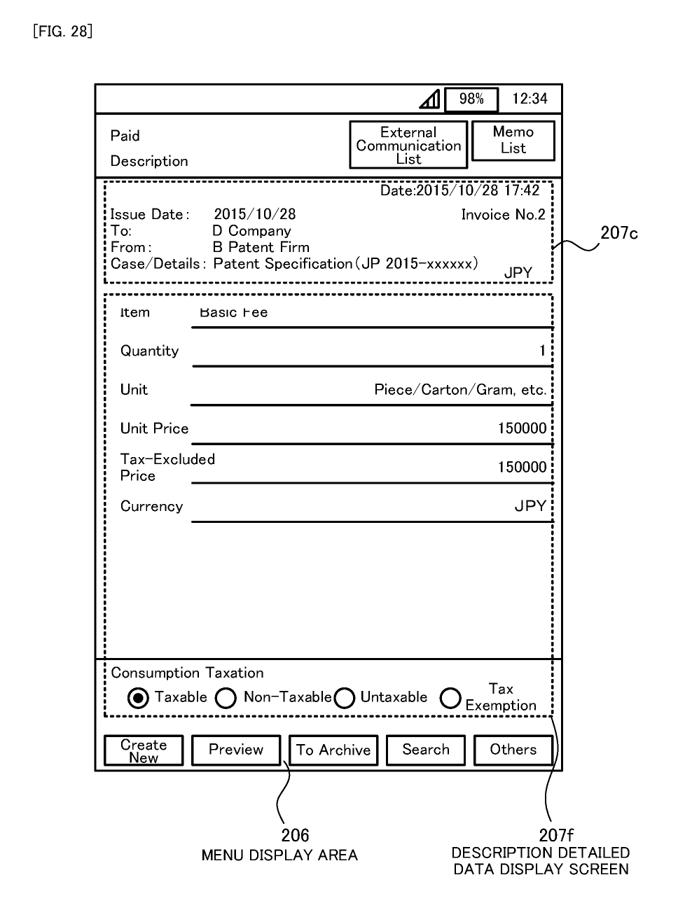

FIG. 28 is a view for explaining a description detailed data display screen that is displayed on the display of the portable terminal device.

The control unit 22 displays a description detailed data display screen 207f on the display 154a, in place of the first screen 207a and second screen 207b, while keeping the third screen 207c displayed.

The description detailed data display screen 207f displays information indicating currency, application or not of consumption taxation, and others, which is not displayed on the second screen 207b.

Refer now back to FIG. 25.

When the detection unit 21 detects that the accounting personnel has tapped a Total area on the second screen 207b, the control unit 22 sends a display request for total detailed data to the invoice management apparatus 1a. The invoice management apparatus 1a refers to the invoice data in question, and sends the total detailed data about the invoice data to the portable terminal device 2a. The portable terminal device 2a displays the total detailed data on the display 154a.

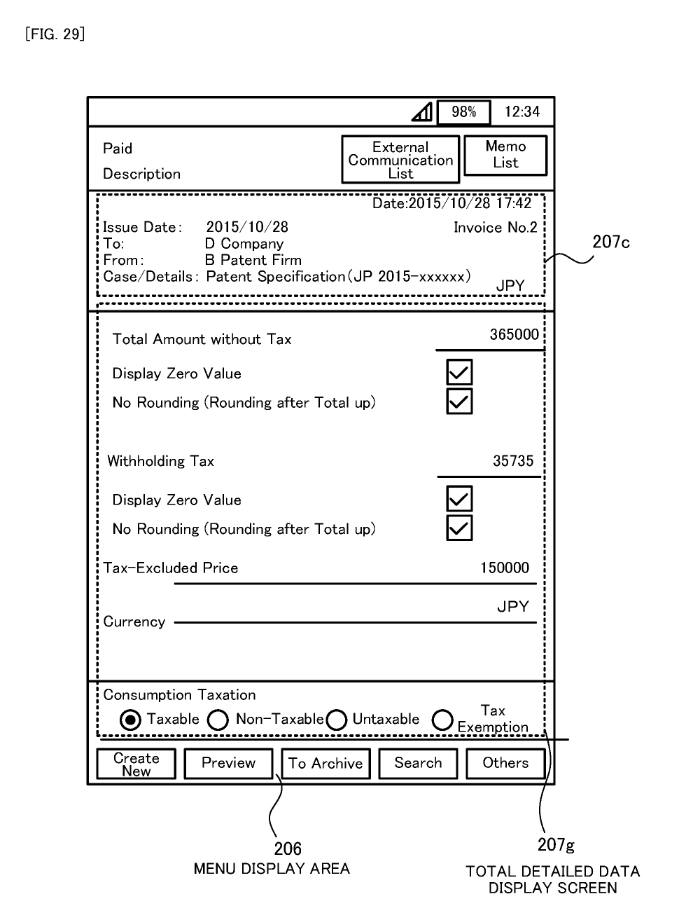

FIG. 29 is a view for explaining a total detailed data display screen that is displayed on the display of the portable terminal device.

The total detailed data display screen 207g displays information indicating a total amount without tax, withholding tax, taxable or non-taxable of consumption tax, and others, which is not displayed on the second screen 207b.

Refer now back to FIG. 25.

When the detection unit 21 detects that the accounting personnel has tapped a Payment Method area on the second screen 207b, the control unit 22 sends a display request for payee detailed data to the invoice management apparatus 1a. The invoice management apparatus 1a refers to the invoice data in question, and sends the payee detailed data with respect to the invoice data to the portable terminal device 2a. Upon receipt of the payee detailed data, the control unit 22 displays the payee detailed data on the display 154a.

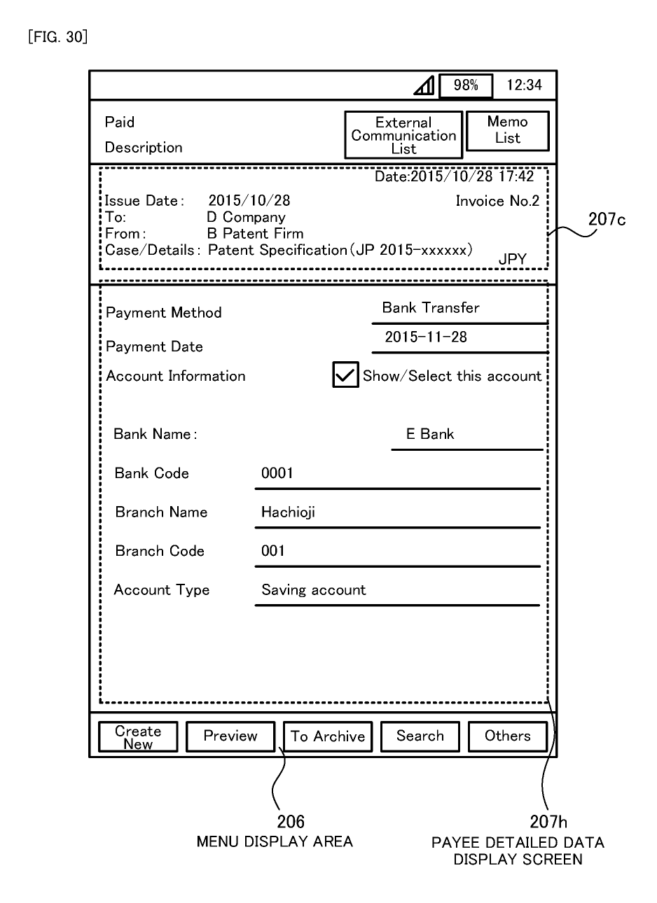

FIG. 30 is a view for explaining a payee detailed data display screen that is displayed on the display of the portable terminal device.

The control unit 22 displays a payee detailed data display screen 207h on the display 154a, in place of the first screen 207a and second screen 207b, while keeping the third screen 207c displayed.

The payee detailed data display screen 207h displays information including a bank code, branch code, account type, and others of a payment destination, which is not displayed on the second screen 207b.

Refer now back to FIG. 25.

(Message)

When the detection unit 21 detects that the accounting personnel has swiped (slid to the right) the first screen 207a or the second screen 207b to the right in a situation where “Description” is selected on the first screen 207a, as illustrated in FIG. 25, the control unit 22 sends a display request for message data to the invoice management apparatus 1a. The data processing unit 11 accesses the message data storage unit 17, and obtains, on the basis of the mail addresses of both sender and recipient accounting persons of the invoice data in question, message data exchanged between the accounting persons who communicate the invoice data. Then, the data processing unit 11 sends the obtained message data to the portable terminal device 2a. Upon receipt of the message data, the control unit 22 displays the message data on the second screen 207b.

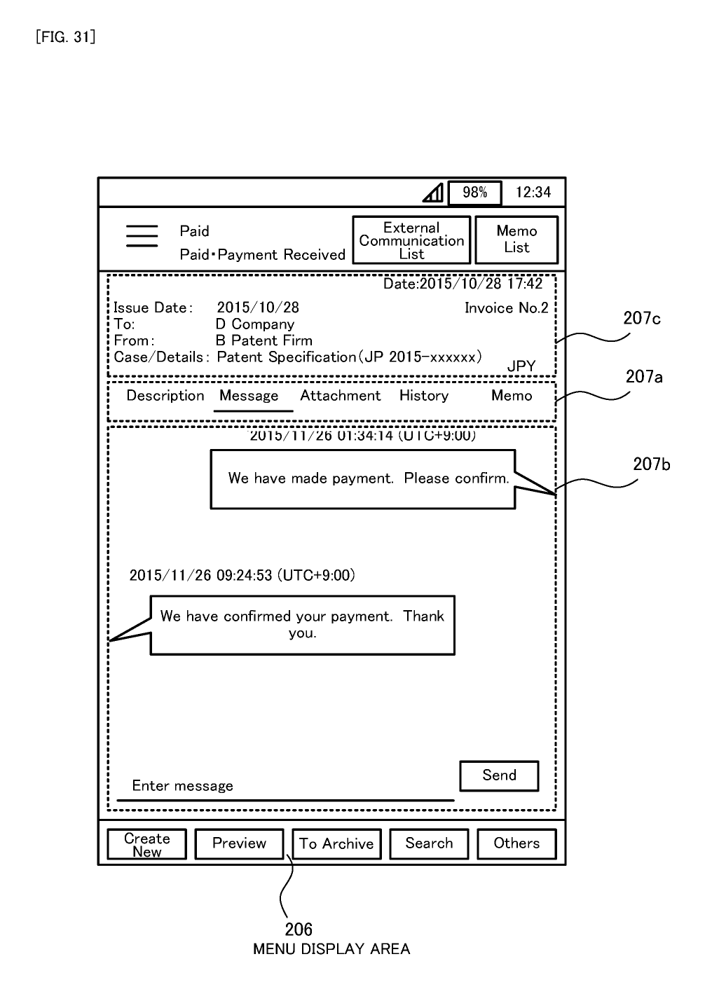

FIG. 31 is a view for explaining message data to be displayed on the second screen.

The second screen 207b displays a history of messages exchanged between accounting persons with respect to invoice data. In addition, the control unit 22 adds an underline to Message on the first screen 207a.

(Attachment)

When the detection unit 21 detects that the accounting personnel has swiped the first screen 207a or second screen 207b to the right in a situation where “Message” is selected on the first screen 207a, the control unit 22 sends a display request for link information (for example, URL or the like) of attached data to the invoice management apparatus 1a. The invoice management apparatus 1a refers to the invoice data in question, and sends the link information of attached data for the invoice data to the portable terminal device 2a. Upon receipt of the link information of the attached data, the control unit 22 displays the link information of the attached data on the second screen 207b.

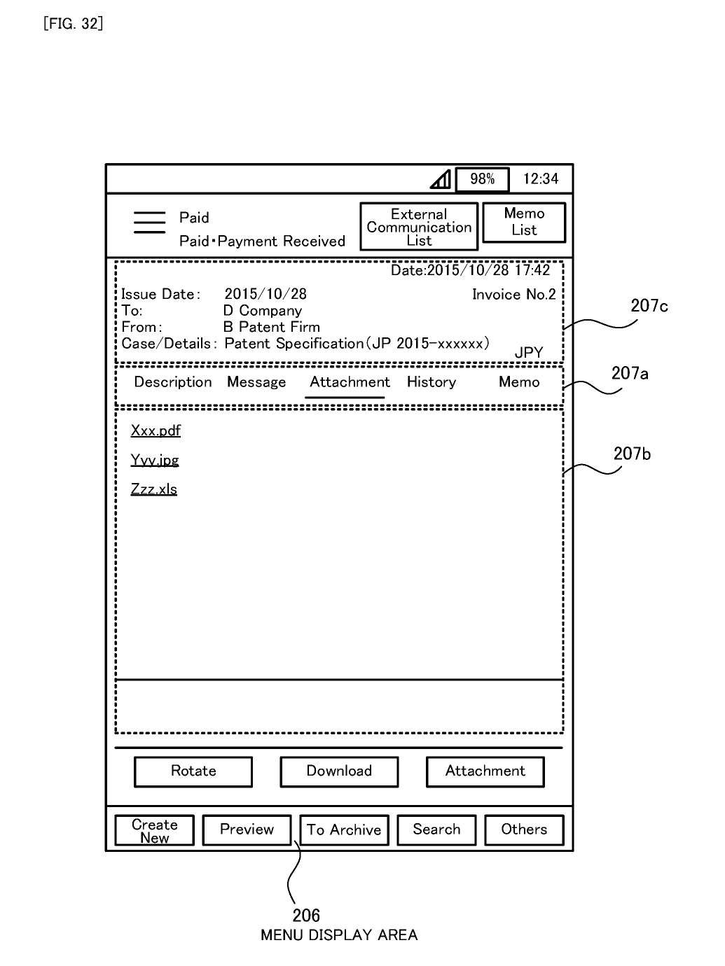

FIG. 32 is a view for explaining link information of attached data to be displayed on the second screen.

The second screen 207b displays a list of the names of attached data attached to the invoice data. In addition, the control unit 22 adds an underline to “Attachment” on the first screen 207a. In this connection, a method of displaying link information is not limited to the illustrated one. For example, in the case of image data, a preview of an image may be displayed on the second screen 207b.

When the detection unit 21 detects that the accounting personnel has tapped the link information of any attached data displayed on the second screen 207b, the control unit 22 sends a display request for the tapped link information to the invoice management apparatus 1a. The invoice management apparatus 1a refers to the link information, and sends the attached data of the link destination to the portable terminal device 2a. Upon receipt of the attached data, the control unit 22 displays the attached data on the second screen 207b.

For example, when the detection unit 21 detects that the accounting personnel has tapped a Rotate button in the case where the attached data being displayed on the second screen 207b is image data, the control unit 22 rotates the image data displayed on the second screen 207b by 90 degrees clockwise, for example.

For example, when the detection unit 21 detects that the accounting personnel has tapped a Download button in the case where the attached data being displayed on the second screen 207b is in pdf format or Excel format, the control unit 22 downloads the attached data to the storage unit 23.

In addition, when the detection unit 21 detects that the accounting personnel has tapped an Attachment button, the control unit 22 displays a list screen listing data stored in the storage unit 23 on the display 154a (not illustrated). Then, when the accounting personnel selects data, the control unit 22 sends the selected data in association with the invoice ID of the currently displayed invoice data (identified on the third screen 207c) to the invoice management apparatus 1a. The invoice management apparatus 1a stores the attached data in association with the invoice data with the invoice ID in the attached file data storage unit 14.

(History)

When the detection unit 21 detects that the accounting personnel has swiped (slid to the right) the first screen 207a or the second screen 207b to the right in a situation where “Attachment” is selected on the first screen 207a, the control unit 22 sends a display request for history data to the invoice management apparatus 1a. The invoice management apparatus 1a refers to the invoice data in question, and sends history data about the invoice data to the portable terminal device 2a. Upon receipt of the history data, the control unit 22 displays the history data on the display 154a.

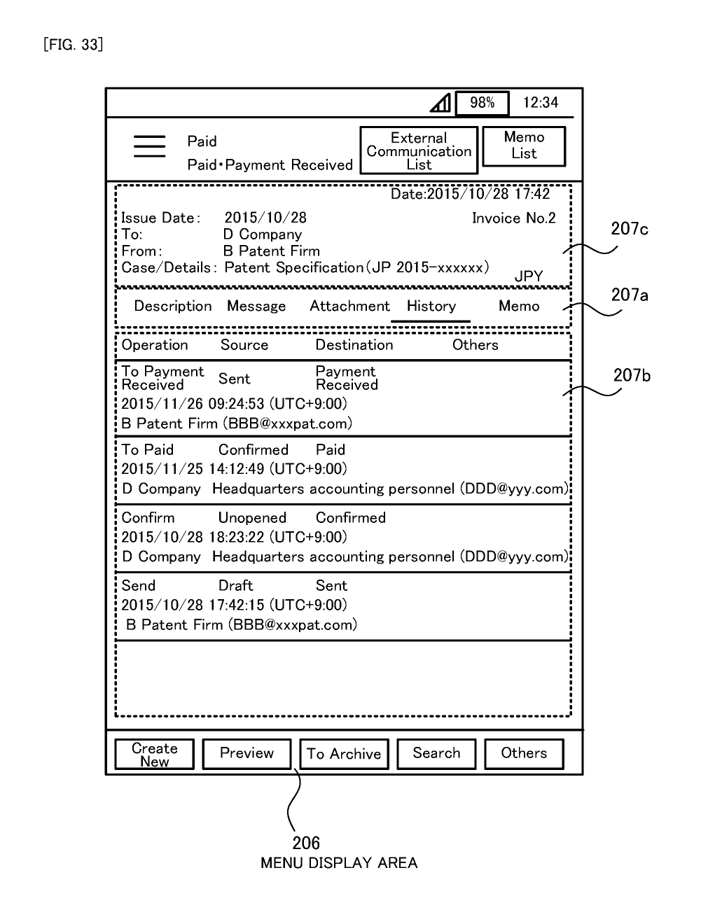

FIG. 33 is a view for explaining history data to be displayed on the second screen.

The second screen 207b displays a history of processes performed on the invoice data.

(Memo)

When the detection unit 21 detects that the accounting personnel has swiped (slid to the right) the first screen 207a or the second screen 207b to the right in a situation where “History” is selected on the first screen 207a, the control unit 22 sends a display request for memo data to the invoice management apparatus 1a. The invoice management apparatus 1a refers to the invoice data in question, and sends memo data about the invoice data to the portable terminal device 2a. The portable terminal device 2a displays the memo data on the display 154a.

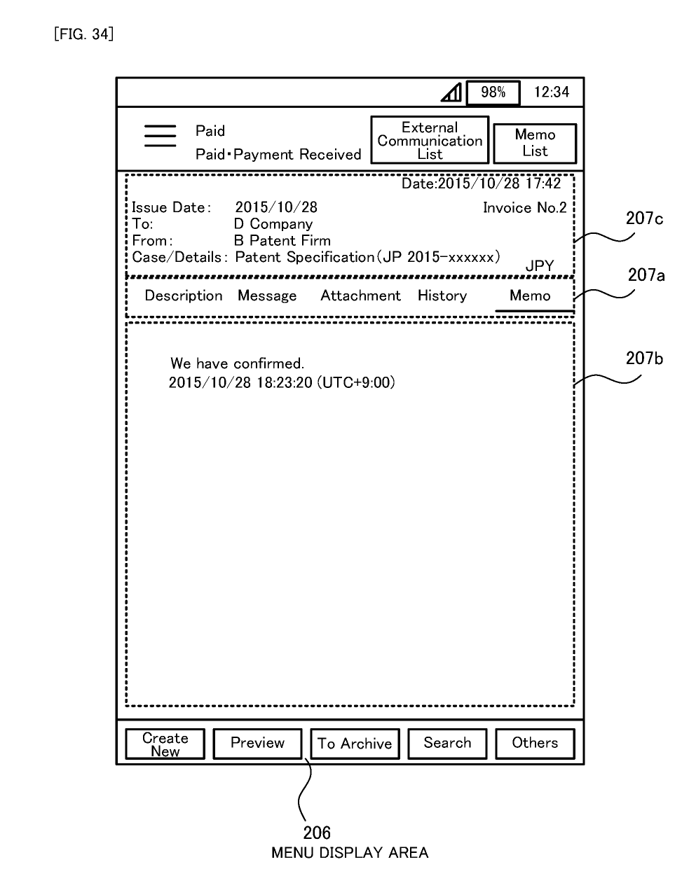

FIG. 34 is a view for explaining memo data to be displayed on the second screen.

The second screen 207b displays memo data associated with the invoice data.

As described above, in the invoice management system of the second embodiment, it is possible to easily switch data (screen) to another that an accounting personnel wants to view, with respect to a certain invoice. In addition, the first screen 207a is displayed, and an underline is added to a currently selected category. This enables the accounting personnel to easily confirm the category of data that he/she is viewing.

In addition, the third screen 207c keeps on displaying header detailed data even when the content displayed on the second screen 207b is changed. This enables the accounting personnel to easily confirm which invoice he/she is viewing.

In this connection, the second embodiment has described the case of switching a screen to another screen under an adjacent category when an accounting personnel swipes to the right. It goes without saying that it is possible to switch the screen to another screen under an adjacent category when the accounting personnel swipes to the left.

In addition, the second embodiment has described the case of switching a screen to another screen under an adjacent category when an accounting personnel performs a swiping operation. It goes without saying that the accounting personnel is able to switch a screen to another screen under a desired category by directly tapping the category. For example, in FIG. 25, when the detection unit 21 detects that the accounting personnel has tapped “Attachment” on the first screen 207a, the control unit 22 displays attached data on the second screen 207b as illustrated in FIG. 32.

In this connection, processes performed by the invoice management apparatus 1, la may be performed by a plurality of apparatuses in a distributed manner.

In addition, in the embodiments, the invoice management apparatus 1, la has various storage units including the invoice data storage unit 12. Alternatively, each storage unit may be provided at a different location from the data processing unit 11 in cloud-based platform.

Note that in the second embodiment, screens are displayed on the portable terminal device 2a. Alternatively, screens illustrated in FIGS. 21 to 34 may be displayed on the terminal device 2a of the first embodiment. In the case where a display connected to the terminal device 2a has a touch-panel function, it is possible to easily confirm information linked with an invoice by performing the same operations as performed on the portable terminal device 2a.

Heretofore, the terminal device and display method of the present invention have been described as the embodiments illustrated. The invention is not limited thereto, and the components of each unit may be replaced with other components having equivalent functions or other components. In addition, other desired configurations and steps may be added to the invention.

Further, two or more desired configurations (features) in the above-described embodiments may be combined.

The above-described processing functions may be implemented by using a computer. In this case, a program is prepared, which describes processes for the functions of the terminal device 2a or portable terminal device 2a. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, Flexible Disks (FD), Magnetic Tapes, etc. The optical discs include DVDs, DVD-RAMs, CD-ROMs, CD-RWs, etc. The magneto-optical recording media include MOs (Magneto-Optical disk), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer over a network, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible to enable users to easily confirm information linked with business documents.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A terminal device comprising:
a memory;
a processor configured to perform a process including:
detecting a screen switching operation performed by a user; and
displaying, with reference to the memory, a first screen for displaying a plurality of category names of categories into which content of business document data is classified and a second screen for displaying data corresponding to each of the categories among data related to the business document data, and displaying data corresponding to one of the category names on the second screen according to the detected screen switching operation,
wherein the process further includes displaying a third screen for displaying identification information unique to the business document data, and
wherein the process further includes displaying, upon detecting that the user has performed a selection operation on the second screen, detailed data with respect to data that was displayed on the second screen before the detecting of the selection operation, in an area where the second screen has been displayed, while keeping the third screen displayed.

2. The terminal device according to claim 1, wherein the process further includes displaying, on the first screen, identifying information for one of the category names corresponding to data currently displayed on the second screen.

3. The terminal device according to claim 1, wherein:
the second screen includes a plurality of selectable areas; and
the process further includes displaying the detailed data according to one of the selectable areas selected on the second screen by the user, in an area where the second screen has been displayed.

4. A display method causing a computer to perform a process comprising:
detecting a screen switching operation performed by a user;
displaying, with reference to a memory, a first screen for displaying a plurality of category names of categories into which content of business document data is classified and a second screen for displaying data corresponding to each of the categories among data related to the business document data, and displaying data corresponding to one of the category names on the second screen according to the detected screen switching operation;
displaying a third screen for displaying identification information unique to the business document data; and
displaying, upon detecting a selection operation performed on the second screen by the user, detailed data with respect to data that was displayed on the second screen before the detecting of the selection operation, in an area where the second screen has been displayed, while keeping the third screen displayed.

5. A non-transitory computer-readable recording medium storing a computer program that causes a computer to perform a process comprising:
detecting a screen switching operation performed by a user;
displaying, with reference to a memory, a first screen for displaying a plurality of category names of categories into which content of business document data is classified and a second screen for displaying data corresponding to each of the categories among data related to the business document data, and displaying data corresponding to one of the category names on the second screen according to the detected screen switching operation;
displaying a third screen for displaying identification information unique to the business document data; and
displaying, upon detecting a selection operation performed on the second screen by the user, detailed data with respect to data that was displayed on the second screen before the detecting of the selection operation, in an area where the second screen has been displayed, while keeping the third screen displayed.
